(19) United States
(12) Patent Application Publication
(10) Pub. No.: US 2022/0132436 A1
(43) Pub. Date: Apr. 28, 2022

(54) BASE STATION APPARATUS, TERMINAL APPARATUS, COMMUNICATION METHOD, AND INTEGRATED CIRCUIT

(71) Applicants: Sharp Kabushiki Kaisha, Sakai City, Osaka (JP); FG Innovation Company Limited, Tuen Mun, New Territories (HK)

(72) Inventors: Masayuki HOSHINO, Sakai City (JP); Shohei YAMADA, Sakai City (JP); Hiroki TAKAHASHI, Sakai City (JP); Liqing LIU, Sakai City (JP); Hidekazu TSUBOI, Sakai City (JP)

(21) Appl. No.: 17/429,389

(22) PCT Filed: Feb. 12, 2020
(86) PCT No.: PCT/JP2020/005399

§ 371 Date: Aug. 9, 2021

(30) Foreign Application Priority Data
Feb. 14, 2019 (JP) 2019-024508

(51) Int. Cl. H04W 52/24; H04W 52/14; H04W 52/42; H04W 52/32

(52) U.S. Cl. CPC H04W 52/242; H04W 52/325; H04W 52/42; H04W 52/146

(57) ABSTRACT

A communication method for a terminal apparatus includes receiving a higher layer configuration including an aggregation transmission parameter and parameters to be applied to transmit power control, and in a case that the aggregation transmission parameter is configured, repeatedly transmitting a transport block N times in N slots. A value for the number N is included in the aggregation transmission parameter, one or multiple path loss reference reference signal parameters are included in the parameters to be applied to the transmit power control, and a downlink path loss estimation corresponding to nth transmission of the N repeated transmissions is calculated by using a path loss reference reference signal identified by the one or multiple path loss reference reference signal parameters, to perform transmit power control for the nth transmission.

### TECHNICAL FIELD

The present invention relates to a base station apparatus, a terminal apparatus, a communication method, and an integrated circuit. This application claims priority based on JP 2019-24508 filed on Feb. 14, 2019, the contents of which are incorporated herein by reference.

### BACKGROUND ART

Technical studies and standardization of Long Term Evolution (LTE)-Advanced Pro and New Radio (NR) technology, as a radio access scheme and a radio network technology for fifth generation cellular systems, are currently conducted by the Third Generation Partnership Project (3GPP) (NPL 1).

The fifth generation cellular system requires three anticipated scenarios for services: enhanced Mobile BroadBand (eMBB) which realizes high-speed, high-capacity transmission, Ultra-Reliable and Low Latency Communication (URLLC) which realizes low-latency, high-reliability communication, and massive Machine Type Communication (mMTC) that allows a large number of machine type devices to be connected in a system such as Internet of Things (IoT).

### CITATION LIST

### Non Patent Literature

NPL 1: RP-161214, NTT DOCOMO, “Revision of SI: Study on New Radio Access Technology”, June 2016

### SUMMARY OF INVENTION

### Technical Problem

An object of an aspect of the present invention is to provide a terminal apparatus, a base station apparatus, a communication method, and an integrated circuit that enable efficient communication in a radio communication system as that described above.

### Solution to Problem

(1) In order to achieve the aforementioned object, aspects of the present invention provide the following measures. Specifically, a communication method according to an aspect of the present invention is a communication method for a terminal apparatus, the communication method including receiving a higher layer configuration including an aggregation transmission parameter and parameters to be applied to transmit power control, and in a case that the aggregation transmission parameter is configured, repeatedly transmitting a transport block N times in N slots, wherein a value for the number N is included in the aggregation transmission parameter, one or multiple path loss reference reference signal parameters are included in the parameters to be applied to the transmit power control, and a downlink path loss estimation corresponding to nth transmission of the N repeated transmissions is calculated by using a path loss reference reference signal identified by the one or multiple path loss reference reference signal parameters, to perform transmit power control for the nth transmission.

(2) In the communication method according to an aspect of the present invention, the one or multiple path loss reference reference signal parameters are parameters for identifying the path loss reference reference signal defined as a remainder obtained by dividing the value of the n by a total number of reference signals included in a set of reference signals to be used for PUSCH path loss estimation.

(3) In the communication method according to an aspect of the present invention, the one or multiple path loss reference reference signal parameters are parameters for identifying, as the path loss reference reference signal, a reference signal corresponding to spatial relation information identified as a remainder obtained by dividing, by a total number of one or multiple pieces of spatial relation information each associated with a PUCCH resource, a sum of the value of the n and a value of an index of spatial relation information associated with a PUCCH resource with a minimum index value among the one or multiple pieces of spatial relation information.

(4) A communication method according to an aspect of the present invention is a communication method for a terminal apparatus, the communication method including transmitting, to a terminal apparatus, a higher layer configuration including an aggregation transmission parameter and parameters to be applied to transmit power control, and in a case that the aggregation transmission parameter is configured, repeatedly receiving a transport block N times in N slots, wherein a value for the number N is included in the aggregation transmission parameter, one or multiple path loss reference reference signal parameters are included in the parameters to be applied to the transmit power control, and a signal received in nth reception of the N repeated receptions is a signal for which the terminal apparatus calculates a corresponding downlink path loss estimation by using a path loss reference reference signal identified by the one or multiple path loss reference reference signal parameters and performs transmit power control.

(5) A terminal apparatus according to an aspect of the present invention is a terminal apparatus including a receiver configured to receive a higher layer configuration including an aggregation transmission parameter and parameters to be applied to transmit power control, and a transmitter configured to repeatedly transmit, in a case that the aggregation transmission parameter is configured, a transport block N times in N slots, wherein a value for the number N is included in the aggregation transmission parameter, one or multiple path loss reference reference signal parameters are included in the parameters to be applied to the transmit power control, and a downlink path loss estimation corresponding to nth transmission of the N repeated transmissions is calculated by using a path loss reference reference signal identified by the one or multiple path loss reference reference signal parameters, to perform transmit power control for the nth transmission.

(6) A base station apparatus according to an aspect of the present invention is a base station apparatus including a transmitter configured to transmit, to a terminal apparatus, a higher layer configuration including an aggregation transmission parameter and parameters to be applied to transmit power control, and a receiver configured to repeatedly receive, in a case that the aggregation transmission parameter is configured, a transport block N times in N slots, wherein a value for the number N is included in the aggregation transmission parameter, one or multiple path loss reference reference signal parameters are included in the parameters to be applied to the transmit power control, and a signal received in nth reception of the N repeated receptions is a signal for which the terminal apparatus calculates a corresponding downlink path loss estimation by using a path loss reference reference signal identified by the one or multiple path loss reference reference signal parameters and performs transmit power control.

(7) An integrated circuit according to an aspect of the present invention is an integrated circuit mounted in a terminal apparatus, the integrated circuit including a receiving unit configured to receive a higher layer configuration including an aggregation transmission parameter and parameters to be applied to transmit power control, and a transmitting unit configured to repeatedly transmit, in a case that the aggregation transmission parameter is configured, a transport block N times in N slots, wherein a value for the number N is included in the aggregation transmission parameter, one or multiple path loss reference reference signal parameters are included in the parameters to be applied to the transmit power control, and a downlink path loss estimation corresponding to nth transmission of the N repeated transmissions is calculated by using a path loss reference reference signal identified by the one or multiple path loss reference reference signal parameters, to perform transmit power control for the nth transmission.

(8) An integrated circuit according to an aspect of the present invention is an integrated circuit mounted in a base station apparatus, the integrated circuit including a transmitting unit configured to transmit, to a terminal apparatus, a higher layer configuration including an aggregation transmission parameter and parameters to be applied to transmit power control, and a receiving unit configured to repeatedly receive, in a case that the aggregation transmission parameter is configured, a transport block N times in N slots, wherein a value for the number N is included in the aggregation transmission parameter, one or multiple path loss reference reference signal parameters are included in the parameters to be applied to the transmit power control, and a signal received in nth reception of the N repeated receptions is a signal for which the terminal apparatus calculates a corresponding downlink path loss estimation by using a path loss reference reference signal identified by the one or multiple path loss reference reference signal parameters and performs transmit power control.

### Advantageous Effects of Invention

According to an aspect of the present invention, a base station apparatus and a terminal apparatus can efficiently communicate with each other.

### BRIEF DESCRIPTION OF DRAWINGS

FIG. 1 is a diagram illustrating a concept of a radio communication system according to an embodiment of the present invention.

FIG. 2 is a diagram illustrating an example of an SS/PBCH block and an SS burst set according to an embodiment of the present invention.

FIG. 3 is a diagram illustrating a schematic configuration of an uplink slot and a downlink slot according to an embodiment of the present invention.

FIG. 4 is a diagram illustrating a relationship of a subframe, a slot, and a mini-slot in a time domain according to an embodiment of the present invention.

FIG. 5 is a diagram illustrating an example of a slot or a subframe according to an embodiment of the present invention.

FIG. 6 is a diagram illustrating an example of beamforming according to an embodiment of the present invention.

FIG. 7 is a diagram illustrating an example of a spatial relation information set configuration according to an embodiment of the present invention.

FIG. 8 is a diagram illustrating an example of a path loss reference set configuration according to an embodiment of the present invention.

FIG. 9 is a schematic block diagram illustrating a configuration of a terminal apparatus 1 according to an embodiment of the present invention.

FIG. 10 is a schematic block diagram illustrating a configuration of a base station apparatus 3 according to an embodiment of the present invention.

### DESCRIPTION OF EMBODIMENTS

Embodiments of the present invention will be described below.

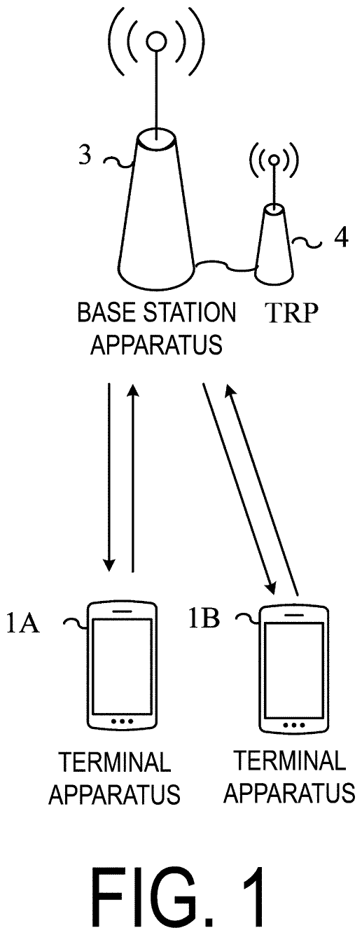

FIG. 1 is a conceptual diagram of a radio communication system according to the present embodiment. In FIG. 1, the radio communication system includes a terminal apparatus 1A, a terminal apparatus 1B, and a base station apparatus 3. The terminal apparatus 1A and the terminal apparatus 1B are also referred to as a terminal apparatus 1 below.

The terminal apparatus 1 is also called a user terminal, a mobile station device, a communication terminal, a mobile device, a terminal, User Equipment (UE), and a Mobile Station (MS). The base station apparatus 3 is also referred to as a radio base station apparatus, a base station, a radio base station, a fixed station, a NodeB (NB), an evolved NodeB (eNB), a Base Transceiver Station (BTS), a Base Station (BS), an NR NodeB (NR NB), NNB, a Transmission and Reception Point (TRP), or gNB. The base station apparatus 3 may include a core network apparatus. Furthermore, the base station apparatus 3 may include one or multiple transmission reception points (TRPs) 4. At least some of the functions/processing of the base station apparatus 3 described below may be the functions/processing of each of the transmission reception points 4 included in the base station apparatus 3. The base station apparatus 3 may use a communicable range (communication area) controlled by the base station apparatus 3, as one or multiple cells to serve the terminal apparatus 1. Furthermore, the base station apparatus 3 may use a communicable range (communication area) controlled by one or multiple transmission reception points 4, as one or multiple cells to serve the terminal apparatus 1. Furthermore, one cell may be divided into multiple beamed areas, and the terminal apparatus 1 may be served in each of the beamed areas. Here, a beamed area may be identified based on a beam index used for beamforming or a precoding index.

A radio communication link from the base station apparatus 3 to the terminal apparatus 1 is referred to as a downlink. A radio communication link from the terminal apparatus 1 to the base station apparatus 3 is referred to as an uplink.

In FIG. 1, in a radio communication between the terminal apparatus 1 and the base station apparatus 3, Orthogonal Frequency Division Multiplexing (OFDM) including a Cyclic Prefix (CP), Single-Carrier Frequency Division Multiplexing (SC-FDM), Discrete Fourier Transform Spread OFDM (DFT-S-OFDM), or Multi-Carrier Code Division Multiplexing (MC-CDM) may be used.

Furthermore, in FIG. 1, in the radio communication between the terminal apparatus 1 and the base station apparatus 3, Universal-Filtered Multi-Carrier (UFMC), Filtered OFDM (F-OFDM), Windowed OFDM, or Filter-Bank Multi-Carrier (FBMC) may be used.

Note that the present embodiment will be described in conjunction with OFDM symbols with the assumption that OFDM is used as a transmission scheme but that use of any other transmission scheme is also included in the present invention.

Furthermore, in FIG. 1, in the radio communication between the terminal apparatus 1 and the base station apparatus 3, the CP need not be used, or the above-described transmission scheme with zero padding may be used instead of the CP. Moreover, the CP or zero passing may be added both forward and backward.

An aspect of the present embodiment may be operated in carrier aggregation or dual connectivity with the Radio Access Technologies (RAT) such as LTE and LTE-A/LTE-A Pro. In this case, the aspect may be used for some or all of the cells or cell groups, or the carriers or carrier groups (e.g., Primary Cells (PCells), Secondary Cells (SCells), Primary Secondary Cells (PSCells), Master Cell Groups (MCGs), or Secondary Cell Groups (SCGs)). Moreover, the aspect may be independently operated and used in a stand-alone manner. In the dual connectivity operation, the Special Cell (SpCell) is referred to as a PCell of the MCG or a PSCell of the SCG, respectively, depending on whether a Medium Access Control (MAC) entity is associated with the MCG or the SCG. In a case that the operation is not in dual connectivity, the Special Cell (SpCell) is referred to as a PCell. The Special Cell (SpCell) supports PUCCH transmission and contention based random access.

In the present embodiment, one or multiple serving cells may be configured for the terminal apparatus 1. The multiple serving cells configured may include one primary cell and one or multiple secondary cells. The primary cell may be a serving cell on which an initial connection establishment procedure has been performed, a serving cell in which a connection re-establishment procedure has been initiated, or a cell indicated as a primary cell in a handover procedure. One or multiple secondary cells may be configured at a point of time in a case that or after a Radio Resource Control (RRC) connection is established. Note that the multiple serving cells configured may include one primary secondary cell. The primary secondary cell may be a secondary cell that is included in the one or multiple secondary cells configured and in which the terminal apparatus 1 can transmit control information in the uplink. Additionally, subsets of two types of serving cells corresponding to a master cell group and a secondary cell group may be configured for the terminal apparatus 1. The master cell group may include one primary cell and zero or more secondary cells. The secondary cell group may include one primary secondary cell and zero or more secondary cells.

Time Division Duplex (TDD) and/or Frequency Division Duplex (FDD) may be applied to the radio communication system according to the present embodiment. The Time Division Duplex (TDD) scheme or the Frequency Division Duplex (FDD) scheme may be applied to all of the multiple cells. Cells to which the TDD scheme is applied and cells to which the FDD scheme is applied may be aggregated.

A carrier corresponding to a serving cell in the downlink is referred to as a downlink component carrier (or a downlink carrier). A carrier corresponding to a serving cell in the uplink is referred to as an uplink component carrier (or an uplink carrier). A carrier corresponding to a serving cell in the sidelink is referred to as a sidelink component carrier (or a sidelink carrier). The downlink component carrier, the uplink component carrier, and/or the sidelink component carrier are collectively referred to as a component carrier (or a carrier).

Physical channels and physical signals according to the present embodiment will be described.

In FIG. 1, the following physical channels are used for the radio communication between the terminal apparatus 1 and the base station apparatus 3.
Physical Broadcast CHannel (PBCH)
Physical Downlink Control CHannel (PDCCH)
Physical Downlink Shared CHannel (PDSCH)
Physical Uplink Control CHannel (PUCCH)
Physical Uplink Shared CHannel (PUSCH)
Physical Random Access CHannel (PRACH)

The PBCH is used to broadcast essential information block ((Master Information Block (MIB), Essential Information Block (EIB), and Broadcast Channel (BCH)) which includes essential information needed by the terminal apparatus 1.

Additionally, the PBCH (also referred to as a physical broadcast channel) may be used to broadcast time indexes within the period of synchronization signal blocks (also referred to as SS/PBCH blocks). Here, the time index is information indicating the indexes of the synchronization signals and the PBCHs within the cell. For example, in a case that the SS/PBCH block is transmitted using the assumption of three transmit beams (transmission filter configuration and Quasi Co-Location (QCL) related to reception spatial parameters), the order of time within a prescribed period or within a configured period may be indicated. Additionally, the terminal apparatus may recognize the difference in time index as a difference in transmit beam. Each synchronization signal block may include a primary synchronization signal and a secondary synchronization signal, a physical broadcast channel, and a reference signal for demodulating the physical broadcast channel. The primary synchronization signal, the secondary synchronization signal, and the reference signal for demodulating the physical broadcast channel will be described below.

The PDCCH is used to transmit (or carry) Downlink Control Information (DCI) in a case of downlink radio communication (radio communication from the base station apparatus 3 to the terminal apparatus 1). Here, one or multiple pieces of DCI (which may be referred to as DCI formats) are defined for transmission of the downlink control information. In other words, a field for the downlink control information is defined as DCI and is mapped to information bits.

For example, the following DCI format may be defined.
DCI format 0_0
DCI format 0_1
DCI format 1_0
DCI format 1_1
DCI format 2_0
DCI format 2_1
DCI format 2_2
DCI format 2_3

DCI format 0_0 may include information indicating PUSCH scheduling information (frequency domain resource allocation and time domain resource allocation).

DCI format 0_1 may include information indicating PUSCH scheduling information (frequency domain resource allocation and time domain resource allocation), information indicating a BandWidth Part (BWP), a Channel State Information (CSI) request, a Sounding Reference Signal (SRS) request, and information related to antenna ports.

DCI format 1_0 may include information indicating PDSCH scheduling information (frequency domain resource allocation and time domain resource allocation).

DCI format 1_1 may include information indicating PDSCH scheduling information (frequency domain resource allocation and time domain resource allocation), information indicating a bandwidth part (BWP), Transmission Configuration Indication (TCI), and information related to the antenna ports.

DCI format 2_0 is used to notify the slot format of one or multiple slots. The slot format is defined as a format in which each OFDM symbol in the slot is classified as downlink, flexible, or uplink. For example, in a case that the slot format is 28, DDDDDDDDDDDDFU is applied to the 14 OFDM symbols in the slot for which slot format 28 is indicated. Here, D is a downlink symbol, F is a flexible symbol, and U is an uplink symbol. Note that the slot will be described below.

DCI format 2_1 is used to notify the terminal apparatus 1 of physical resource blocks and OFDM symbols which may be assumed to involve no transmission. Note that this information may be referred to as a pre-emption indication (intermittent transmission indication).

DCI format 2_2 is used for transmission of the PUSCH and a Transmit Power Control (TPC) command for the PUSCH.

DCI format 2_3 is used to transmit a group of TPC commands for transmission of sounding reference signals (SRSs) by one or multiple terminal apparatuses 1. Additionally, the SRS request may be transmitted along with the TPC command. In addition, the SRS request and the TPC command may be defined in DCI format 2_3 for uplink with no PUSCH and PUCCH or uplink in which the transmit power control for the SRS is not associated with the transmit power control for the PUSCH.

Here, the DCI for the downlink is also referred to as downlink grant or downlink assignment. Here, the DCI for the uplink is also referred to as uplink grant or Uplink assignment. The Cyclic Redundancy Check (CRC) parity bits added to the DCI format transmitted on one PDCCH are scrambled with a System Information-Radio Network Temporary Identifier (SI-RNTI), a Paging-Radio Network Temporary Identifier (P-RNTI), a Cell-Radio Network Temporary Identifier (C-RNTI), a Configured Scheduling-Radio Network Temporary Identifier (CS-RNTI), a Random Access-Radio Network Temporary Identity (RA-RNTI), or a Temporary C-RNTI. The SI-RNTI may be an identifier used for broadcasting of the system information. The P-RNTI may be an identifier used for paging and notification of system information modification. The C-RNTI, the MCS-C-RNTI, and the CS-RNTI are identifiers for identifying a terminal apparatus within a cell. The Temporary C-RNTI is an identifier for identifying the terminal apparatus 1 that has transmitted a random access preamble during a contention based random access procedure. The C-RNTI (identifier (identification information) of terminal apparatus) is used to control the PDSCH or the PUSCH in one or multiple slots. The CS-RNTI is used to periodically allocate a resource for the PDSCH or the PUSCH. The MCS-C-RNTI is used to indicate the use of a prescribed MCS table for grant-based transmission. The Temporary C-RNTI (TC-RNTI) is used to control PDSCH transmission or PUSCH transmission in one or multiple slots. The Temporary C-RNTI is used to schedule re-transmission of a random access message 3 and transmission of a random access message 4. The RA-RNTI is determined in accordance with frequency and time position information regarding the physical random access channel on which the random access preamble has been transmitted.

The PUCCH is used to transmit Uplink Control Information (UCI) in a case of uplink radio communication (radio communication from the terminal apparatus 1 to the base station apparatus 3). Here, the uplink control information may include Channel State Information (CSI) used to indicate a downlink channel state. The uplink control information may include Scheduling Request (SR) used to request an UL-SCH resource. The uplink control information may include a Hybrid Automatic Repeat request ACKnowledgement (HARQ-ACK). The HARQ-ACK may indicate an HARQ-ACK for downlink data (Transport block, Medium Access Control Protocol Data Unit (MAC PDU), or Downlink-Shared CHannel (DL-SCH)).

The PDSCH is used to transmit downlink data (Downlink Shared CHannel (DL-SCH)) from a Medium Access Control (MAC) layer. Furthermore, in a case of the downlink, the PSCH is used to transmit System Information (SI), a Random Access Response (RAR), and the like.

The PUSCH may be used to transmit uplink data (Uplink-Shared CHannel (UL-SCH)) from the MAC layer or to transmit the HARQ-ACK and/or CSI along with the uplink data. Furthermore, the PSCH may be used to transmit the CSI only or the HARQ-ACK and CSI only. In other words, the PSCH may be used to transmit the UCI only.

Here, the base station apparatus 3 and the terminal apparatus 1 exchange (transmit and/or receive) signals with each other in higher layers. For example, the base station apparatus 3 and the terminal apparatus 1 may transmit and/or receive Radio Resource Control (RRC) signaling (also referred to as a Radio Resource Control (RRC) message or Radio Resource Control (RRC) information) in an RRC layer. The base station apparatus 3 and the terminal apparatus 1 may transmit and/or receive a Medium Access Control (MAC) control element in a Medium Access Control (MAC) layer. Here, the RRC signaling and/or the MAC control element is also referred to as higher layer signaling. The higher layer as used herein means a higher layer as viewed from the physical layer, and thus may include one or multiple of the MAC layer, the RRC layer, an RLC layer, a PDCP layer, a Non Access Stratum (NAS) layer, and the like. For example, in the processing of the MAC layer, the higher layer may include one or multiple of the RRC layer, the RLC layer, the PDCP layer, the NAS layer, and the like.

The PDSCH or the PUSCH may be used to transmit the RRC signaling and the MAC control element. In this regard, in the PDSCH, the RRC signaling transmitted from the base station apparatus 3 may be signaling common to multiple terminal apparatuses 1 in a cell. The RRC signaling transmitted from the base station apparatus 3 may be dedicated signaling for a certain terminal apparatus 1 (also referred to as dedicated signaling). In other words, terminal apparatus-specific (UE-specific) information may be transmitted through dedicated signaling to the certain terminal apparatus 1. Additionally, the PUSCH may be used to transmit UE Capabilities in the uplink.

In FIG. 1, the following downlink physical signals are used for downlink radio communication. Here, the downlink physical signals are not used to transmit information output from the higher layers but are used by the physical layer.
Synchronization signal (SS)
Reference Signal (RS)

The synchronization signal may include a Primary Synchronization Signal (PSS) and a Secondary Synchronization Signal (SSS). A cell ID may be detected by using the PSS and SSS.

The synchronization signal is used for the terminal apparatus 1 to establish synchronization in a frequency domain and a time domain in the downlink. Here, the synchronization signal may be used for the terminal apparatus 1 to select precoding or a beam in precoding or beamforming performed by the base station apparatus 3. Note that the beam may be referred to as a transmission or reception filter configuration, or a spatial domain transmission filter or a spatial domain reception filter.

A reference signal is used for the terminal apparatus 1 to perform channel compensation on a physical channel. Here, the reference signal is used for the terminal apparatus 1 to calculate the downlink CSI. Furthermore, the reference signal may be used for a numerology such as a radio parameter or subcarrier spacing, or used for Fine synchronization that allows 1-1-T window synchronization to be achieved.

According to the present embodiment, at least one of the following downlink reference signals are used.
Demodulation Reference Signal (DMRS)
Channel State Information Reference Signal (CSI-RS)
Phase Tracking Reference Signal (PTRS)
Tracking Reference Signal (TRS)

The DMRS is used to demodulate a modulated signal. Note that two types of reference signals may be defined as the DMRS: a reference signal for demodulating the PBCH and a reference signal for demodulating the PDSCH or that both reference signals may be referred to as the DMRS. The CSI-RS is used for measurement of Channel State Information (CSI) and beam management, and a transmission method for a periodic, semi-persistent, or aperiodic CSI reference signal is applied to the CSI-RS. For the CSI-RS, a Non-Zero Power (NZP) CSI-RS and a CSI-RS with zero transmit power (or receive power) (Zero Power (ZP)) may be defined. Here, the ZP CSI-RS may be defined as a CSI-RS resource that has zero transmit power or that is not transmitted. The PTRS is used to track phase on the time axis to ensure frequency offset caused by phase noise. The TRS is used to ensure Doppler shift during fast movement. Note that the TRS may be used as one configuration of the CSI-RS. For example, a radio resource may be configured with the CSI-RS for one port as a TRS.

According to the present embodiment, one or multiple of the following uplink reference signals are used.
Demodulation Reference Signal (DMRS)
Phase Tracking Reference Signal (PTRS)
Sounding Reference Signal (SRS)

The DMRS is used to demodulate a modulated signal. Note that two types of reference signals may be defined as the DMRS: a reference signal for demodulating the PUCCH and a reference signal for demodulating the PUSCH or that both reference signals may be referred to as the DMRS. The SRS is used for measurement of uplink channel state information (CSI), channel sounding, and beam management. The PTRS is used to track phase on the time axis to ensure frequency offset caused by phase noise.

The downlink physical channels and/or the downlink physical signals are collectively referred to as a downlink signal. The uplink physical channels and/or the uplink physical signals are collectively referred to as an uplink signal. The downlink physical channels and/or the uplink physical channels are collectively referred to as a physical channel. The downlink physical signals and/or the uplink physical signals are collectively referred to as a physical signal.

The BCH, the UL-SCH, and the DL-SCH are transport channels. A channel used in the Medium Access Control (MAC) layer is referred to as a transport channel A unit of the transport channel used in the MAC layer is also referred to as a Transport Block (TB) and/or a MAC Protocol Data Unit (PDU). A Hybrid Automatic Repeat reQuest (HARQ) is controlled for each transport block in the MAC layer. The transport block is a unit of data that the MAC layer delivers to the physical layer. In the physical layer, the transport block is mapped to a codeword, and coding processing is performed for each codeword.

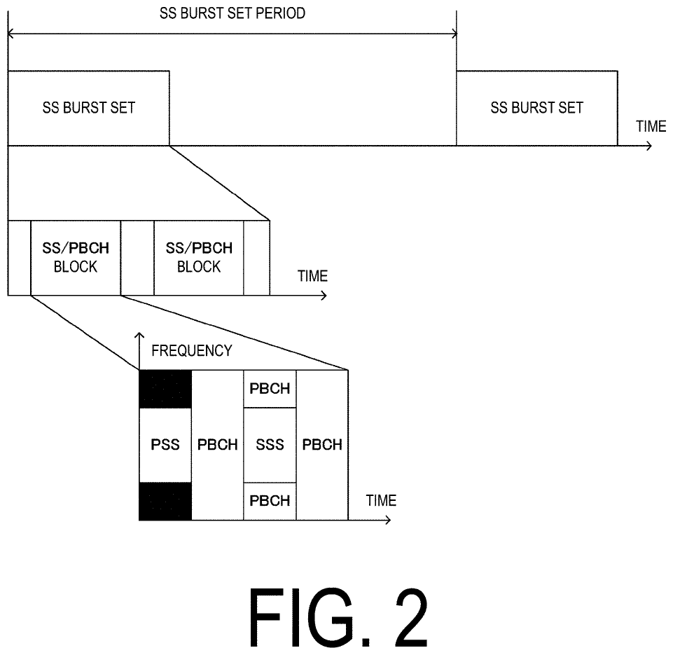

FIG. 2 is a diagram illustrating an example of SS/PBCH blocks (also referred to as synchronization signal blocks, SS blocks, and SSBs) and SS burst sets (also referred to as synchronization signal burst sets) according to the present embodiment. FIG. 2 illustrates an example in which two SS/PBCH blocks are included in a periodically transmitted SS burst set, and the SS/PBCH block includes four OFDM symbols.

The SS/PBCH block is a unit block including at least synchronization signals (PSS, SSS) and/or PBCHs. Transmitting the signals/channels included in the SS/PBCH block is described as transmitting the SS/PBCH block. In a case of transmitting the synchronization signals and/or the PBCHs using one or multiple SS/PBCH blocks in the SS burst set, the base station apparatus 3 may use an independent downlink transmit beam for each SS/PBCH block.

In FIG. 2, PSS, SSS, and PBCHs are time/frequency multiplexed in one SS/PBCH block. However, the order in which the PSS, the SSS, and/or the PBCHs are multiplexed in the time domain may be different from the order in the example illustrated in FIG. 2.

The SS burst set may be transmitted periodically. For example, a period used for initial access and a period configured for a connected (Connected or RRC_Connected) terminal apparatus may be defined. Furthermore, the period configured for the connected (Connected or RRC_Connected) terminal apparatus may be configured in the RRC layer. Additionally, the period configured for the connected (Connected or RRC_Connected) terminal may be a period of a radio resource in the time domain during which transmission is potentially to be performed, and in practice, whether the transmission is to be performed during the period may be determined by the base station apparatus 3. Furthermore, the period used for the initial access may be predefined in specifications or the like.

The SS burst set may be determined based on a System Frame Number (SFN). Additionally, a start position of the SS burst set (boundary) may be determined based on the SFN and the period.

The SS/PBCH block is assigned with an SSB index (which may be referred to as the SSB/PBCH block index) depending on the temporal position in the SS burst set. The terminal apparatus 1 calculates the SSB index, based on the information of the PBCH and/or the information of the reference signal included in the detected SS/PBCH block.

The SS/PBCH blocks with the same relative time in each SS burst set in the multiple SS burst sets are assigned with the same SSB index. The SS/PBCH blocks with the same relative time in each SS burst set in the multiple SS burst sets may be assumed to be QCLed (or the same downlink transmit beam may be assumed to be applied to these SS/PBCH blocks). In addition, antenna ports in the SS/PBCH blocks with the same relative time in each SS burst set in the multiple SS burst sets may be assumed to be QCLed for average delay, Doppler shift, and spatial correlation.

Within a certain SS burst set period, the SS/PBCH block assigned with the same SSB index may be assumed to be QCLed for average delay, average gain, Doppler spread, Doppler shift, and spatial correlation. A configuration corresponding to one or multiple SS/PBCH blocks (or the SS/PBCH blocks may be reference signals) that are QCLed may be referred to as a QCL configuration.

The number of SS/PBCH blocks (which may be referred to as the number of SS blocks or the SSB number) may be defined as, for example, the number of SS/PBCH blocks within an SS burst, an SS burst set, or an SS/PBCH block period. Additionally, the number of SS/PBCH blocks may indicate the number of beam groups for cell selection within the SS burst, the SS burst set, or the SS/PBCH block period. Here, the beam group may be defined as the number of different SS/PBCH blocks or the number of different beams included in the SS burst, the SS burst set, or the SS/PBCH block period.

Hereinafter, the reference signal described in the present embodiment includes a downlink reference signal, a synchronization signal, an SS/PBCH block, a downlink DM-RS, a CSI-RS, an uplink reference signal, an SRS, and/or an uplink DM-RS. For example, the downlink reference signal, the synchronization signal, and/or the SS/PBCH block may be referred to as a reference signal. The reference signals used in the downlink include a downlink reference signal, a synchronization signal, an SS/PBCH block, a downlink DM-RS, a CSI-RS, and the like. The reference signals used in the uplink include an uplink reference signal, an SRS and/or an uplink DM-RS, and the like.

The reference signal may also be used for Radio Resource Measurement (RRM). The reference signal may also be used for beam management.

Beam management may be a procedure of the base station apparatus 3 and/or the terminal apparatus 1 for matching directivity of an analog and/or digital beam in a transmission apparatus (the base station apparatus 3 in the downlink and the terminal apparatus 1 in the uplink) with directivity of an analog and/or digital beam in a reception apparatus (the terminal apparatus 1 in the downlink and the base station apparatus 3 in the uplink) to acquire a beam gain.

Note that the procedures described below may be included as a procedure for configuring, setting, or establishing a beam pair link.
Beam selection
Beam refinement
Beam recovery

For example, the beam selection may be a procedure for selecting a beam in communication between the base station apparatus 3 and the terminal apparatus 1. Furthermore, the beam refinement may be a procedure for selecting a beam having a higher gain or changing a beam to an optimum beam between the base station apparatus 3 and the terminal apparatus 1 according to the movement of the terminal apparatus 1. The beam recovery may be a procedure for re-selecting the beam in a case that the quality of a communication link is degraded due to blockage caused by a blocking object, a passing human being, or the like in communication between the base station apparatus 3 and the terminal apparatus 1.

Beam management may include beam selection and beam refinement. Note that the beam recovery may include the following procedures.
Detection of beam failure
Discovery of a new beam
Transmission of a beam recovery request
Monitoring of a response to the beam recovery request

For example, the Reference Signal Received Power (RSRP) of the SSS included in the CSI-RS or the SS/PBCH block may be used or a CSI may be used in selecting the transmit beam of the base station apparatus 3 at the terminal apparatus 1. Additionally, as a report to the base station apparatus 3, the CSI-RS Resource Index (CRI) may be used, or an index indicated in the PBCHs included in the SS/PBCH block and/or in a sequence of demodulation reference signals (DMRSs) used for demodulation of the PBCHs may be used.

Additionally, the base station apparatus 3 indicates the CRI or the time index of the SS/PBCH in indicating the beam to the terminal apparatus 1, and the terminal apparatus 1 receives the beam, based on the CRI or the time index of the SS/PBCH that is indicated. At this time, the terminal apparatus 1 may configure a spatial filter, based on the CRI or the time index of the SS/PBCH that is indicated, and receive the beam. Additionally, the terminal apparatus 1 may receive the beam by using the assumption of Quasi Co-Location (QCL). One signal (such as an antenna port, a synchronization signal, a reference signal, etc.) being “QCLed” with another signal (such as an antenna port, a synchronization signal, a reference signal, etc.) or “using the assumption of QCL” for these signals can be interpreted as the one signal being associated with the other signal.

In a case that a Long Term Property of a channel on which one symbol in one antenna port is carried may be estimated from a channel on which one symbol in the other antenna port is carried, the two antenna ports are said to be quasi co-located (QCLed). The long term property of the channel includes at least one of a delay spread, a Doppler spread, a Doppler shift, an average gain, or an average delay. For example, in a case that an antenna port 1 and an antenna port 2 are quasi co-located (QCLed) with respect to the average delay, this means that a reception timing for the antenna port 2 may be estimated from a reception timing for the antenna port 1.

The QCL may also be expanded to beam management. For this purpose, spatially expanded QCL may be newly defined. For example, the long term property of a channel in spatial QCL assumption may be an Angle of Arrival (AoA), a Zenith angle of Arrival (ZoA), or the like and/or an angle spread, for example, Angle Spread of Arrival (ASA) or a Zenith angle Spread of Arrival (ZSA), a transmission angle (AoD, ZoD, or the like) or an angle spread of the transmission angle, for example, an Angle Spread of Departure (ASD) or a Zenith angle Spread of Departure (ZSD), or Spatial Correlation, or a reception spatial parameter in a radio link or channel.

For example, in a case that the antenna port 1 and the antenna port 2 may be considered to be QCLed with respect to a reception spatial parameter, this means that a reception beam (reception spatial filter) in which a signal from the antenna port 2 is received may be inferred from a reception beam in which a signal from the antenna port 1 is received.

As QCL types, combinations of long term properties that may be considered to be QCLed may be defined. For example, the following types may be defined.
Type A: Doppler shift, Doppler spread, average delay, delay spread
Type B: Doppler shift, Doppler spread
Type C: Average delay, Doppler shift
Type D: Reception spatial parameter

The above-described QCL types may configure and/or indicate the assumption of QCL of the one or two reference signals and the PDCCH or the PDSCH DMRS in the RRC and/or MAC layer and/or DCI as a Transmission Configuration Indication (TCI). For example, in a case that the index #2 of the SS/PBCH block and the QCL type A+QCL type D are configured and/or indicated as one state of the TCI in a case that the terminal apparatus 1 receives the PDCCH, then at the time of reception of the PDCCH DMRS, the terminal apparatus 1 may receive the PDCCH DMRS and perform synchronization and channel estimation, with the Doppler shift, Doppler spread, average delay, delay spread, and reception spatial parameter in the reception of SS/PBCH block index #2 considered as the long term properties of the channels. At this time, the reference signal (in the example described above, the SS/PBCH block) indicated by the TCI may be referred to as a source reference signal, and the reference signal (in the above-described example, the PDCCH DMRS) affected by the long term property inferred from the long term property of the channel in a case that the source reference signal is received may be referred to as a target reference signal. Additionally, for the TCI, the RRC configures multiple TCI states and a combination of the source reference signal and the QCL type for each state, and the TCI may be indicated to the terminal apparatus 1 by using the MAC layer or DCI.

According to this method, operations of the base station apparatus 3 and the terminal apparatus 1 equivalent to beam management may be defined based on the QCL assumption for the spatial domain and radio resources (time and/or frequency) as beam management and beam indication/report.

Similarly, as a configuration related to the uplink QCL assumption, spatial relation information (SpatialRelationInfo) may be configured for the uplink physical channel and/or the sounding reference signal. The spatial relation information is information used to apply a separately applied reception or transmission filter configuration to the transmission filter for the sounding reference signal, to acquire a beam gain. For specifying the separately applied reception or transmission filter configuration, any of the synchronization signal block, the CSI reference signal, and the sounding reference signal is configured as a signal to be received or transmitted. In this manner, a beam gain can be acquired for the uplink physical channel and/or the sounding reference signal.

The subframe will now be described. The subframe in the present embodiment may also be referred to as a resource unit, a radio frame, a time period, or a time interval.

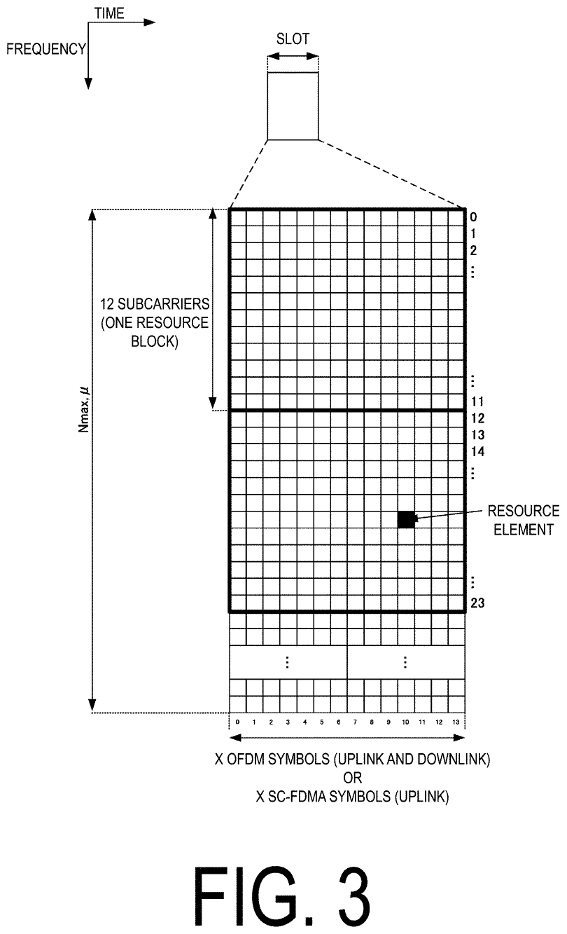

FIG. 3 is a diagram illustrating a general configuration of an uplink and a downlink slots according to a first embodiment of the present invention. Each of the radio frames is 10 ms in length. Additionally, each of the radio frames includes 10 subframes and W slots. In addition, one slot includes X OFDM symbols. In other words, the length of one subframe is 1 ms. For each of the slots, time length is defined based on subcarrier spacings. For example, in a case that the subcarrier spacing of an OFDM symbol is 15 kHz and Normal Cyclic Prefixes (NCPs) are used, X=7 or X=14, and X=7 ad X=14 correspond to 0.5 ms and 1 ms, respectively. In addition, in a case that the subcarrier spacing is 60 kHz, X=7 or X=14, and X=7 and X=14 correspond to 0.125 ms and 0.25 ms, respectively. Additionally, for example, for X=14, W=10 in a case that the subcarrier spacing is 15 kHz, and W=40 in a case that the subcarrier spacing is 60 kHz. FIG. 3 illustrates a case of X=7 as an example. Note that a case of X=14 can be similarly configured by expanding the case of X=7. Furthermore, the uplink slot is defined similarly, and the downlink slot and the uplink slot may be defined separately. Additionally, the bandwidth of the cell of FIG. 3 may also be defined as a part of the band (BandWidth Part (BWP)). In addition, the slot may be referred to as a Transmission Time Interval (TTI). The slot need not be defined as a TTI. The TTI may be a transmission period for transport blocks.

The signal or the physical channel transmitted in each of the slots may be represented by a resource grid. The resource grid is defined by multiple subcarriers and multiple OFUM symbols. The number of subcarriers constituting one slot depends on each of the downlink and uplink bandwidths of a cell. Each element in the resource grid is referred to as a resource element. The resource element may be identified by using a subcarrier number and an OFDM symbol number.

The resource grid is used to represent mapping of a certain physical downlink channel (such as the PDSCH) or a certain physical uplink channel (such as the PUSCH) to resource elements. For example, for a subcarrier spacing of 15 kHz, in a case that the number X of OFDM symbols included in a subframe is 14 and NCPs are used, one physical resource block is defined by 14 continuous OFUM symbols in the time domain and by 12*Nmax continuous subcarriers in the frequency domain. Nmax is the maximum number of resource blocks determined by a subcarrier spacing configuration μ described below. In other words, the resource grid includes (14*12*Nmax, μ) resource elements. Extended CPs (ECPs) are supported only at a subcarrier spacing of 60 kHz, and thus one physical resource block is defined by 12 (the number of OFDM symbols included in one slot)*4 (the number of slots included in one subframe) in the time domain=48 continuous OFDM symbols, 12*Nmax, μ continuous subcarriers in the frequency domain, for example. In other words, the resource grid includes (48*12*Nmax, μ) resource elements.

As resource blocks, a common resource block, a physical resource block, and a virtual resource block are defined. One resource block is defined as 12 subcarriers that are continuous in the frequency domain. Subcarrier index 0 at reference resource block index 0 may be referred to as a reference point (which may also be referred to as point A). The common resource blocks are resource blocks numbered in ascending order from 0 at each subcarrier spacing configuration μ starting at the reference point A. The resource grid described above is defined by the common resource blocks. The physical resource blocks are resource blocks numbered in ascending order from 0 included in a bandwidth part (BWP) described below, and the physical resource blocks are resource blocks numbered in ascending order from 0 included in the bandwidth part (BWP). A certain physical uplink channel is first mapped to a virtual resource block. Thereafter, the virtual resource block is mapped to a physical resource block.

Now, the subcarrier spacing configuration μ will be described. As described above, multiple OFDM numerologies are supported in NR. In a certain BWP, the subcarrier spacing configuration μ=0, 1, . . . 5) and the cyclic prefix length are given for a downlink BWP by the higher layer and for an uplink BWP by the higher layer. In this regard, given μ, a subcarrier spacing Δf is given by Δf=2\hat{ }μ*15 (kHz).

At the subcarrier spacing configuration μ, the slots are counted in ascending order from 0 to N\hat{ }{subframe, μ}_{slot}−1 within the subframe, and counted in ascending order from 0 to N\hat{ }{frame, μ}_{slot}−1 within the frame. N\hat{ }{slot}_{symb} continuous OFDM symbols are in the slot, based on the slot configuration and the cyclic prefix. N\hat{ }{slot}_{symb} is 14. The start of the slot n\hat{ }{μ}_{s} within the subframe is temporally aligned with the start of the n\hat{ }{μ}_{s} N\hat{ }{slot}_{symb}th OFDM symbol within the same subframe.

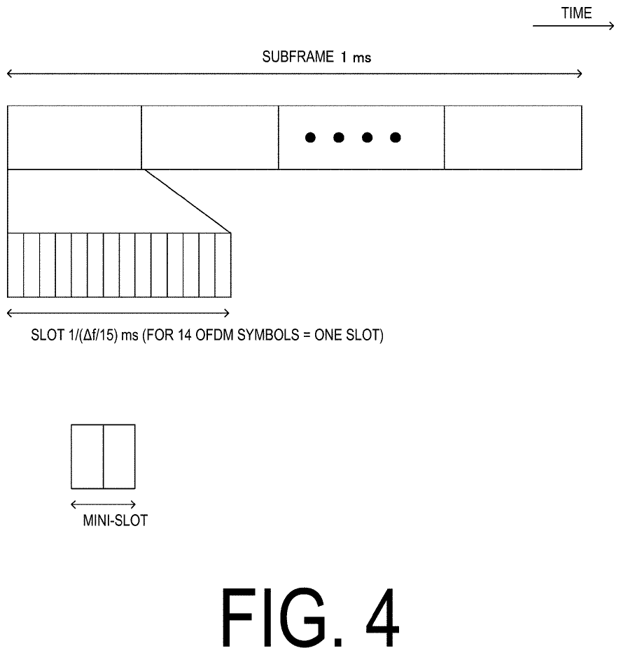

The subframe, the slot, and a mini-slot will now be described. FIG. 4 is a diagram illustrating the relationship of a subframe, slots, and mini-slots in the time domain. As illustrated in FIG. 4, three types of time units are defined. The subframe is 1 ms regardless of the subcarrier spacing. The number of OFDM symbols included in the slot is 7 or 14, and the slot length depends on the subcarrier spacing. Here, in a case that the subcarrier spacing is 15 kHz, 14 OFDM symbols are included in one subframe. The downlink slot may be referred to as PDSCH mapping type A. The uplink slot may be referred to as PUSCH mapping type A.

The mini-slot (which may be referred to as a sub-slot) is a time unit including OFDM symbols that are less in number than the OFDM symbols included in the slot. FIG. 4 illustrates, by way of example, a case in which the mini-slot includes 2 OFDM symbols. The OFDM symbols in the mini-slot may match the timing for the OFDM symbols constituting the slot. Note that the smallest unit of scheduling may be a slot or a mini-slot. Additionally, allocation of mini-slots may be referred to as non-slot based scheduling. Mini-slots being scheduled may also be expressed as resources being scheduled for which the relative time positions of the start positions of the reference signal and the data are fixed. The downlink mini-slot may be referred to as PDSCH mapping type B. The uplink mini-slot may be referred to as PUSCH mapping type B.

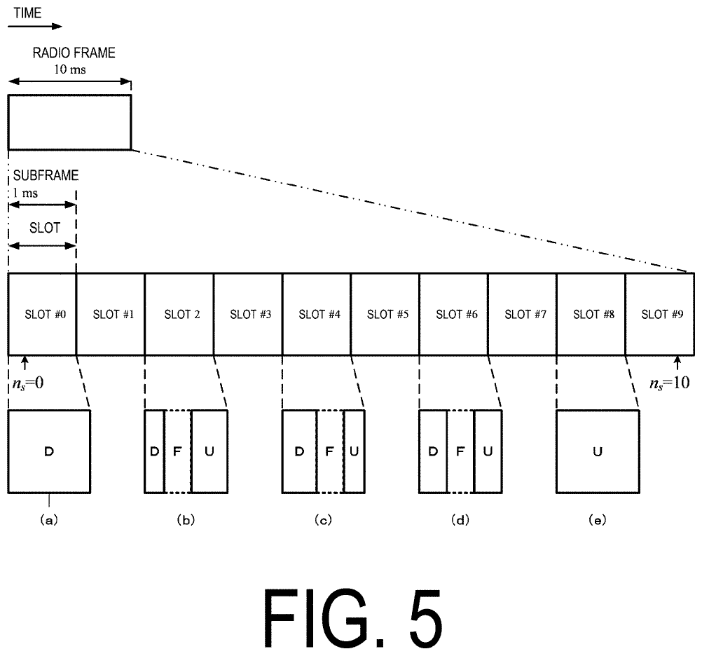

FIG. 5 is a diagram illustrating an example of a slot format. In this regard, a case in which the slot length is 1 ms at a subcarrier spacing of 15 kHz is illustrated as an example. In FIG. 5, D represents the downlink, and U represents the uplink. As illustrated in FIG. 5, during a certain time interval (for example, the minimum time interval to be allocated to one UE in the system), at least one or multiple of the following types of symbols may be included:
downlink symbols,
flexible symbols, and
uplink symbols. Note that the ratio of these symbols may be preset as a slot format.
   Additionally, the definition may be made based on the number of downlink OFDM symbols included in the slot, and the start position and end position of the symbols within the slot. Additionally, the number of uplink OFDM symbols or DFT-S-OFDM symbols included in the slot or the start position and end position of the symbols within the slot may be defined. Note that the slot being scheduled may be expressed as resources being scheduled for which the relative time positions of the reference signal and the slot boundary are fixed.

The terminal apparatus 1 may receive a downlink signal or a downlink channel in the downlink symbols or the flexible symbols. The terminal apparatus 1 may transmit an uplink signal or a downlink channel in the uplink symbols or the flexible symbols.

FIG. 5(a) illustrates an example of a certain time interval (which may be referred to as, for example, a minimum unit of time resource that can be allocated to one UE, a time unit, or the like, additionally, a set of multiple minimum units of time resources may be referred to as a time unit) in which all of the slot is used for downlink transmission, and in FIG. 5(b), the slot is used such that in the first time resource, for example, the uplink is scheduled via the PDCCH and that after a flexible symbol including a processing delay of the PDCCH, a time for switching from downlink to uplink, and generation of a transmission signal, an uplink signal is transmitted. In FIG. 5(c), the slot is used such that in the first time resource, the PDCCH and/or the downlink PDSCH is transmitted and that after a gap for a processing delay, a time for switching from downlink to uplink, and generation of a transmission signal, the PUSCH or PUCCH is transmitted. Here, for example, the uplink signal may be used to transmit the HARQ-ACK and/or CSI, namely, the UCI. In FIG. 5(d), the slot is used such that in the first time resource, the PDCCH and/or the PDSCH is transmitted and that after a gap for a processing delay, a time for switching from downlink to uplink, and generation of a transmit signal, the uplink PUSCH and/or PUCCH is transmitted. Here, for example, the uplink signal may be used to transmit the uplink data, namely, the UL-SCH. In FIG. 5(e), the entire slot is used for uplink transmission (PUSCH or PUCCH).

The above-described downlink part and uplink part may include multiple OFDM symbols as is the case with LTE.

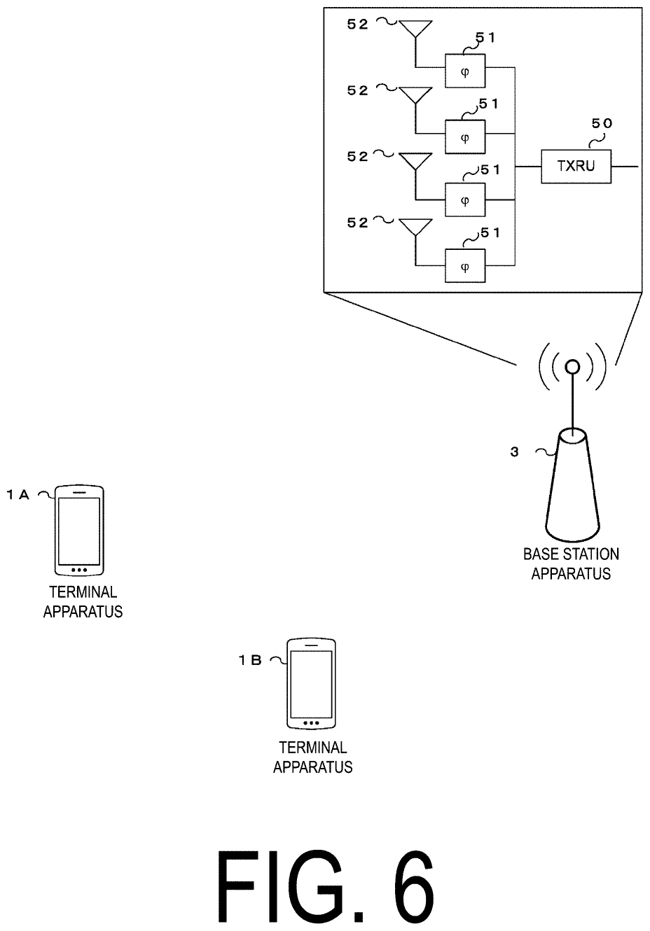

FIG. 6 is a diagram illustrating an example of beamforming. Multiple antenna elements are connected to one Transceiver unit (TXRU) 50. The phase is controlled by using a phase shifter 51 for each antenna element and a transmission is performed from an antenna element 52, thus allowing a beam for a transmit signal to be directed in any direction. Typically, the TXRU may be defined as an antenna port, and only the antenna port may be defined for the terminal apparatus 1. Controlling the phase shifter 51 allows setting of directivity in any direction. Thus, the base station apparatus 3 can communicate with the terminal apparatus 1 by using a high gain beam.

Hereinafter, the bandwidth part (BWP) will be described. The BWP is also referred to as a carrier BWP. The BWP may be configured for each of the downlink and the uplink. The BWP is defined as a set of continuous physical resources selected from continuous subsets of common resource blocks. The terminal apparatus 1 can be configured with up to four BWPs such that one downlink carrier BWP is activated at a certain time. The terminal apparatus 1 can be configured with up to four BWPs such that one uplink carrier BWP is activated at a certain time. In a case of carrier aggregation, the BWP may be configured in each serving cell. At this time, one BWP being configured in a certain serving cell may be expressed as no BWP being configured. Two or more BWPs being configured may also be expressed as the BWP being configured.

MAC entity Operation

An activated serving cell always includes one active (activated) BWP. BWP switching for a certain serving cell is used to activate an inactive (deactivated) BWP and to deactivate an active (activated) BWP. BWP switching for a certain serving cell is controlled by the PDCCH indicating downlink allocation or uplink grant. BWP switching for a certain serving cell may be further controlled by a BWP inactivity timer or by the MAC entity itself at the initiation of a random access procedure. In the addition of the SpCell (PCell or PSCell) or the activation of the SCell, one of the BWPs is initially active without reception of the PDCCH indicating downlink allocation or uplink grant. The initially active BWP may be designated in an RRC message sent from the base station apparatus 3 to the terminal apparatus 1. The active BWP for a certain serving cell is designated in the RRC or PDCCH sent from the base station apparatus 3 to the terminal apparatus 1. In an Unpaired spectrum (TDD bands or the like), the DL BWP and the UL BWP are paired, and the BWP switching is common to the UL and DL. In the active BWP for each of the activated serving cells for which the BWP is configured, the MAC entity of the terminal apparatus 1 applies normal processing. The normal processing includes transmitting a UL-SCH, transmitting a RACH, monitoring the PDCCH, transmitting the PUCCH, transmitting the SRS, and receiving the DL-SCH. In the inactive BWP for each of the activated serving cells for which the BWP is configured, the MAC entity of the terminal apparatus 1 does not transmit the UL-SCH, does not transmit the RACH, does not monitor the PDCCH, does not transmit the PUCCH, does not transmit the SRS, and does not receive the DL-SCH. In a case that a certain serving cell is deactivated, the active BWP may be configured to be absent (e.g., the active BWP is deactivated).

### RRC Operation

BWP information elements (IEs) included in the RRC message (broadcast system information or information sent in a dedicated RRC message) is used to configure the BWP. The RRC message transmitted from the base station apparatus 3 is received by the terminal apparatus 1. For each serving cell, a network (such as the base station apparatus 3) configures, for the terminal apparatus 1, at least an initial BWP including at least a downlink BWP and one uplink BWP (such as a case that the serving cell is configured with the uplink) or two uplink BWPs (such as a case that a supplementary uplink is used). Furthermore, the network may configure an additional uplink BWP or downlink BWP for a certain serving cell. The BWP configuration is divided into uplink parameters and downlink parameters. Additionally, the BWP configuration is also divided into common parameters and dedicated parameters. The common parameters (such as a BWP uplink common IE and a BWP downlink common IE) are cell specific. The common parameters for the initial BWP of the primary cell are also provided by using system information. For all the other serving cells, the network provides the common parameters through dedicated signals. The BWP is identified by a BWP ID. For the initial BWP, the BWP ID is 0. For each of the other BWPs, the BWP ID takes a value ranging from 1 to 4.

The dedicated parameters for the uplink BWP include an SRS configuration. The uplink BWP corresponding to the dedicated parameters for the uplink BWP is associated with one or multiple SRSs corresponding to the SRS configuration included in the dedicated parameters for the uplink BWP.

For the terminal apparatus 1, one primary cell and up to 15 secondary cells may be configured.

Hereinafter, a random access procedure will be described. The random access procedure is classified into two procedures, a Contention Based (CB) procedure and a non-contention based (non-CB, which may also be referred to as Contention Free (CF)) procedure. The contention based random access is also referred to as CBRA, and the non-contention based random access is also referred to as CI-RA. The random access procedure is initiated by a PDCCH order, a MAC entity, a beam failure notification from a lower layer, an RRC or the like.

The contention based random access procedure is initiated by a PDCCH order, a MAC entity, a beam failure notification from a lower layer, an RRC, or the like. In a case that the beam failure notification is provided by the physical layer of the terminal apparatus 1 to the MAC entity of the terminal apparatus 1, the MAC entity of the terminal apparatus 1 initiates the random access procedure in a case that a certain condition is satisfied. A beam failure recovery procedure may refer to the procedure for determining whether the certain condition is satisfied and initiating the random access procedure in a case that the beam failure notification is provided to the MAC entity of the terminal apparatus 1 from the physical layer of the terminal apparatus 1. This random access procedure is a random access procedure for a beam failure recovery request. The random access procedure initiated by the MAC entity includes a random access procedure initiated by a scheduling request procedure. The random access procedure for the beam failure recovery request may or may not be considered as a random access procedure initiated by the MAC entity. The random access procedure for the beam failure recovery request and the random access procedure initiated by the scheduling request procedure may include different procedures, and thus the random access procedure for the beam failure recovery request may be distinguished from the scheduling request procedure. The random access procedure for the beam failure recovery request and the scheduling request procedure may be random access procedures initiated by the MAC entity. In a certain embodiment, the random access procedure initiated by the scheduling request procedure may be referred to as a random access procedure initiated by the MAC entity, and the random access procedure for the beam failure recovery request may be referred to as a random access procedure based on the beam failure notification from the lower layer. Hereinafter, initiation of the random access procedure in a case of reception of the beam failure notification from the lower layer may mean the initiation of the random access procedure for the beam failure recovery request.

The terminal apparatus 1 performs a contention based random access procedure at the time of initial access in a state where the terminal apparatus 1 is not connected (in communication) with the base station apparatus 3, and/or at the time of a scheduling request in a case that the terminal apparatus 1 is connected to the base station apparatus 3 and that transmittable uplink data or sidelink data is generated in the terminal apparatus 1. However, the application of the contention based random access is not limited to the usage described above. The generation of transmittable uplink data in the terminal apparatus 1 may include triggering of a buffer status report corresponding to the transmittable uplink data. The generation of the transmittable uplink data in the terminal apparatus 1 may include a pending scheduling request, which has been triggered based on the generation of the transmittable uplink data. The generation of the transmittable sidelink data in the terminal apparatus 1 may include triggering of a buffer status report corresponding to the transmittable sidelink data. The generation of the transmittable sidelink data in the terminal apparatus 1 may include a pending scheduling request, which has been triggered based on the generation of the transmittable sidelink data.

The non-contention based random access procedure may be initiated in a case that the terminal apparatus 1 receives information indicating the initiation of the random access procedure from the base station apparatus 3. The non-contention based random access procedure may be initiated in a case that the MAC layer of the terminal apparatus 1 receives the notification of the beam failure from the lower layer. The non-contention based random access may be used to quickly establish uplink synchronization between the terminal apparatus 1 and the base station apparatus 3 in a case that the base station apparatus 3 and the terminal apparatus 1 are in connection but that handover or a transmission timing for a mobile station device is not enabled. The non-contention based random access may be used to transmit a beam failure recovery request in a case that a beam failure occurs in the terminal apparatus 1. However, the application of the non-contention based random access is not limited to the usage descried above. Note that information indicating the initiation of the random access procedure may be referred to as message 0, Msg. 0, NR-PDCCH order, PDCCH order, etc. Note that, in a case that the random access preamble index indicated by message 0 has a prescribed value (for example, in a case that all of the bits indicating the index are 0), the terminal apparatus 1 may perform a contention based random access procedure for randomly selecting and transmitting one preamble from a set of preambles available for the terminal apparatus 1.

The terminal apparatus 1 receives the random access configuration information via the higher layer before initiation of the random access procedure. The random access configuration information may include resources available for preamble transmission and various parameters for the preamble transmission (the number of transmissions and power configuration), information regarding associated SS/PBCH blocks, or information for determining/configuring the above-described information. Note that, the random access configuration information may include information that is common within the cell, and dedicated information varying may be included for each terminal. However, a part of the random access configuration information may be associated with all the SS/PBCH blocks in the SS burst set. However, a part of the random access configuration information may be associated with all of the one or multiple CSI-RSs configured. However, a part of the random access configuration information may be associated with one downlink transmit beam (or beam index). However, a part of the random access configuration information may be associated with one SS/PBCH block in the SS burst set. However, a part of the random access configuration information may be associated with one of the one or multiple CSI-RSs configured. However, a part of the random access configuration information may be associated with one downlink transmit beam (or beam index). However, information associated with one SS/PBCH block, one CSI-RS, and/or one downlink transmit beam may include one corresponding SS/PBCH block, one CSI-RS, and/or index information for specifying one downlink transmit beam (which may be, for example, an SSB index, a beam index, or a QCL configuration index). However, the random access configuration information may be configured for each SS/PBCH block in the SS burst set, or one piece of random access configuration information may be configured that is common to all the SS/PBCH blocks in the SS burst set. The terminal apparatus 1 may receive one or multiple pieces of random access configuration information through a downlink signal, and each of the one or multiple pieces of random access configuration information may be associated with an SS/PBCH block (which may be a CSI-RS or a downlink transmit beam). The terminal apparatus 1 may select one of the one or multiple SS/PBCH blocks received (which may be CSI-RSs or downlink transmit beams), and perform a random access procedure by using the random access configuration information associated with the selected SS/PBCH block.

The random access procedure used in a case that the terminal apparatus 1 receives message 0 from the base station apparatus 3 is achieved by transmitting and receiving multiple messages between the terminal apparatus 1 and the base station apparatus 3.

### <Message 0>

The base station apparatus 3 allocates one or multiple non-contention based random access preambles to the terminal apparatus 1 by downlink dedicated signalling (also referred to as message 0 or Msg0). However, the non-contention based random access preamble may refer to a random access preamble that is not included in the set notified by broadcast signaling. In a case of transmitting multiple reference signals, the base station apparatus 3 may allocate, to the terminal apparatus 1, multiple non-contention based random access preambles corresponding to at least some of the multiple reference signals. Message 0 may be indication information used by the base station apparatus 3 to indicate the initiation of the random access procedure to the terminal apparatus 1. Message 0 may be a handover (HO) command generated by the target base station apparatus 3 and transmitted by the source base station apparatus 3 for handover. Message 0 may be an SCG change command transmitted by the base station apparatus 3 to change the secondary cell group. The handover command and the SCG change command are also referred to as synchronization reconfiguration. The synchronization reconfiguration (reconfiguration with sync or the like) is transmitted in an RRC message. The synchronization reconfiguration is used for RRC reconfiguration with synchronization with the PCell (such as the handover command) and RRC reconfiguration with synchronization with the PSCell (such as the SCG change command) Message 0 may be transmitted on the RRC signal and/or the PDCCH. Message 0 transmitted on the PDCCH may be referred to as a PDCCH order. The PDCCH order may be transmitted in DCI in a certain DCI format. Message 0 may include information for allocating a non-contention based random access preamble. The bit information notified in message 0 may include preamble index information, SSB index information, mask index information (which may be referred to as a RACH occasion index), Supplemental Uplink (SUL) information, BWP index information, SRS Resource Indicator (SRI) information, Reference Signal Selection Indicator information, Random Access Configuration Selection Indicator information, RS type selection indication information, Single/Multiple Message 1 Transmission Indicator information (Single/Multiple Msg.1 Transmission Indicator) and/or TCI. The preamble index information is information indicating one or multiple preamble indexes used to generate the random access preamble. However, in a case that the preamble index information is a prescribed value, the terminal apparatus 1 may randomly select one of the one or multiple random access preambles available for the contention based random access procedure. The SSB index information is information indicating an SSB index corresponding to any one of the one or multiple SS/PBCH blocks transmitted by the base station apparatus 3. The terminal apparatus 1 which has received message 0 specifies a group of PRACH occasions to which the SSB index indicated by the SSB index information is mapped. The SSB index mapped to each PRACH occasion is determined by a PRACH configuration index, a higher layer parameter SB-perRACH-Occasion, and a higher layer parameter cb-preamblePerSSB. The mask index information is information indicating the index of the PRACH occasion available for transmission of the random access preamble. However, the PRACH occasion indicated by the mask index information may be one particular PRACH occasion, or may indicate selectable multiple PRACH occasions, or respective different indexes may indicate one PRACH occasion and selectable multiple PRACH occasions. The mask index information may be information indicating some of the PRACH occasions of a group of one or multiple PRACH occasions defined by prach-ConfigurationIndex. However, the mask index information may be information indicating some of the PRACH occasions in the group of PRACH occasions to which the specific SSB index specified by the SSB index information is mapped.

### <Message 1>

The terminal apparatus 1, which has received message 0, transmits the allocated non-contention based random access preamble over the physical random access channel. The transmitted random access preamble may be referred to as message 1 or Msg1. The random access preamble is configured to notify the base station apparatus 3 of information in multiple sequences. For example, in a case that 64 types of sequences are provided, 6-bit information (which may be ra-PreambleIndex or a preamble index) can be indicated to the base station apparatus 3. This information is indicated as a Random Access preamble Identifier, and by monitoring a random access response (message 2) corresponding to the information, the terminal apparatus 1 can specify message 2 addressed to the terminal apparatus 1 from the base station apparatus 3. A preamble sequence is selected from a preamble sequence set that uses the preamble index. A procedure for selecting a random access resource (including a time/frequency resource and/or the preamble index) in the MAC layer of the terminal apparatus 1 will be described. The terminal apparatus 1 uses a procedure described below to set a value for the preamble index (which may be referred to as PREAMBLE_INDEX) of the transmitted random access preamble. In a case that (1) the random access procedure has been initiated by the beam failure notification from the lower layer, (2) random access resources (which may be PRACH occasions) have been provided that are intended for non-contention based random access for a beam failure recovery request associated with the SS/PBCH blocks (also referred to as the SSBs) or the CSI-RSs by the RRC parameter, and (3) the RSRP exceeds a prescribed threshold in one or more SS/PBCH blocks or CSI-RSs, the terminal apparatus 1 selects the SS/PBCH blocks or CSI-RSs with the RSRP exceeding the prescribed threshold, and sets ra-PreambleIndex associated with the selected SS/PBCH blocks to the preamble index. In a case that (1) ra-PreambleIndex has been provided by the PDCCH or RRC, (2) the value of ra-PreambleIndex is not a value indicating the contention based random access procedure (e.g., 0b000000), and (3) RRC does not associate the SS/PBCH blocks or CSI-RSs with the random access resources for non-contention based random access, the terminal apparatus 1 sets ra-PreambleIndex signaled, to the preamble index. 0bxxxxxx means a bit sequence allocated in a 6-bit information field. In a case that (1) RRC associates the SS/PBCH blocks with the random access resources for non-contention based random access, and (2) one or more SS/PBCH blocks with the RSRP exceeding a prescribed threshold are available among the associated SS/PBCH blocks, the terminal apparatus 1 selects one of the SS/PBCH blocks with the RSRP exceeding the prescribed threshold, and sets, to the preamble index, ra-PreambleIndex associated with the selected SS/PBCH block.

The terminal apparatus 1, in a case that (1) RRC associates the CSI-RSs with the random access resources for non-contention based random access, and (2) one or more CSI-RSs with the RSRP exceeding a threshold are available among the associated CSI-RSs, the terminal apparatus 1 selects one of the CSI-RSs with the RSRP exceeding the prescribed threshold, and sets, to the preamble index, ra-PreambleIndex associated with the selected CSI-RS. In a case that none of the above-described conditions are satisfied, the terminal apparatus 1 performs the contention based random access procedure. In the contention based random access procedure, the terminal apparatus 1 selects the SS/PBCH block with the RSRP of the SS/PBCH block exceeding the configured threshold, and selects a preamble group. In a case that the relationship between the SS/PBCH block and the random access preamble is configured, the terminal apparatus 1 randomly selects ra-PreambleIndex from the one or multiple random access preambles associated with the selected SS/PBCH block and the selected preamble group, and sets ra-PreambleIndex selected, to the preamble index. However, the terminal apparatus 1 may perform the contention based random access procedure in a case that ra-PreambleIndex indicated by message 0 is a prescribed value (e.g., 0b000000). However, in a case that ra-PreambleIndex indicated by message 0 is the prescribed value (e.g., 0b000000), the terminal apparatus 1 may randomly select one of the one ore multiple random access preamble indexes available for the contention based random access. The base station apparatus 3 may transmit, to the terminal apparatus 1, the resource configuration for each SS/PBCH block and/or the resource configuration for each CSI-RS in the RRC message. The terminal apparatus 1 receives, from the base station apparatus 3, the resource configuration for each SS/PBCH block and/or the resource configuration for each CSI-RS in the RRC message. The base station apparatus 3 may transmit, to the terminal apparatus 1, the mask index information and/or the SSB index information in message 0. The terminal apparatus 1 acquires, from the base station apparatus 3, the mask index information and/or the SSB index information in message 0. The terminal apparatus 1 may select a reference signal (SS/PBCH block or CSI-RS) based on certain a condition. The terminal apparatus 1 may specify the next available PRACH occasion, based on the mask index information, the SSB index information, the resource configuration indicated by the RRC parameter, and the selected reference signal (SS/PBCH block or CSI-RS). The MAC entity of the terminal apparatus 1 may indicate to the physical layer that the physical layer is to transmit the random access preamble by using the selected PRACH occasion. However, in a case that the SRI configuration information is indicated by message 0, the terminal apparatus 1 transmits one or multiple random access preambles by using an antenna port and/or an uplink transmit beam corresponding to one or multiple SRS transmission resources indicated in the SRI configuration information.

### <Message 2>

The base station apparatus 3, which has received message 1, generates a random access response including an uplink grant for indicating, to the terminal apparatus 1, that the terminal apparatus 1 is to perform transmission, and transmits the generated random access response to the terminal apparatus 1 on DL-SCH. The random access response may be referred to as message 2 or Msg2. Additionally, the base station apparatus 3 calculates deviation of the transmission timing between the terminal apparatus 1 and the base station apparatus 3 from the received random access preamble, and includes, in message 2, transmission timing adjustment information (Timing Advance Command) for adjusting the deviation. The base station apparatus 3 includes, in message 2, a random access preamble identifier corresponding to the received random access preamble. The base station apparatus 3 transmits, on the downlink PDCCH, RA-RNTI for indicating a random access response addressed to the terminal apparatus 1, which has transmitted the random access preamble. The RA-RNTI is determined in accordance with frequency and time position information regarding the physical random access channel on which the random access preamble has been transmitted. Here, message 2 (downlink PSCH) may include the index of an uplink transmit beam used for transmission of the random access preamble. Information for determining an uplink transmit beam to be used for transmission of message 3 may be transmitted by using the downlink PDCCH and/or message 2 (downlink PSCH). In this regard, the information for determining the uplink transmit beam to be used for transmission of message 3 may include information indicating a difference (adjustment, correction) from the index of the precoding used for transmission of the random access preamble. Additionally, the random access response may include a transmit power control command (TPC command) indicating a correction value for a power control adjustment value used for transmit power for message 3.

Based on transmission and reception of the multiple messages described above, the terminal apparatus 1 can synchronize with the base station apparatus 3 and transmit uplink data to the base station apparatus 3.

Hereinafter, slot aggregation transmission (multi-slot transmission) according to the present embodiment will be described.

A higher layer parameter pusch-AggregationFactor is used to indicate the number of repetition transmissions of data (a transport block). The higher layer parameter pusch-AggregationFactor indicates a value of one of 2, 4, and 8. The base station apparatus 3 may transmit, to the terminal apparatus 1, the higher layer parameter pusch-AggregationFactor indicating the number of data transmission repetitions. The base station apparatus 3 can cause, using pusch-AggregationFactor, the terminal apparatus 1 to repeat transmission of the transport block a prescribed number of times. The terminal apparatus 1 may receive the higher layer parameter pusch-AggregationFactor from the base station apparatus 3 and may repeat transmission of the transport block by using the number of repetitions indicated in pusch-AggregationFactor thus received. However, in a case of not receiving pusch-AggregationFactor from the base station apparatus, the terminal apparatus 1 may consider the number of repetition transmissions of the transport block as one. In other words, in this case, the terminal apparatus 1 may perform only one transmission of the transport block scheduled by the PDCCH. In other words, in a case that the terminal apparatus 1 does not receive pusch-AggregationFactor from the base station apparatus, the terminal apparatus 1 need not perform slot aggregation transmission (multi-slot transmission) on the transport block scheduled by the PDCCH.

Specifically, the terminal apparatus 1 may receive the PDCCH including the DCI format provided with the CRC scrambled with the C-RNTI or the MCS-C-RNTI, and transmit the PUSCH scheduled by the PDCCH. In a case that pusch-AggregationFactor is configured for the terminal apparatus 1, the terminal apparatus 1 may transmit the PUSCH N times in N continuous slots starting with the slot in which the PUSCH is first transmitted. A single PUSCH transmission (transmission of a transport block) may be performed per slot. In other words, transmission of the same transport block (repetition transmission) is performed only once within one slot. The value of N is indicated by pusch-AggregationFactor. In a case that pusch-AggregationFactor is not configured for the terminal apparatus 1, N may have a value of one. The slot in which the PUSCH is first transmitted may be given by the slot in which the PDCCH is detected or the like. As an example, the slot may be given as (Expression 1) Floor (n*2^{μPUSCH}/2^{μPDCCH})+K₂. The function Floor (A) outputs a maximum integer that does not exceed A. Here, n is the slot in which the PDCCH scheduling the PUSCH is detected, and μ_{PUSCH} is a subcarrier spacing configuration for the PUSCH, and μ_{PDCCH} is a subcarrier spacing configuration for the PDCCH. Additionally, K₂ has a value of one of j, j+1, j+2, and j+3. The value of j is a value specified for the subcarrier spacing of the PUSCH. For example, in a case that the subcarrier spacing to which the PUSCH is applied is 15 kHz or 30 kHz, the value of j may be one slot. For example, in a case that the subcarrier spacing to which the PUSCH is applied is 60 kHz, the value of j may be two slots. For example, in a case that the subcarrier spacing to which the PUSCH is applied is 120 kHz, the value of j may be three slots.

Furthermore, the terminal apparatus 1 may receive a configuration and/or an indication related to PUSCH time domain resource allocation. The configuration and/or indication related to the PUSCH time domain resource allocation may be an index providing an effective combination of a starting symbol S for the PUSCH and the number L of continuous allocated symbols, and may be referred to as a start and length indicator (SLIV). The PUSCH time domain resource allocation given based on the PDCCH scheduling the PUSCH may be applied to continuous N slots. That is, the same symbol allocation (the same starting symbol S and the same number L of continuous allocated symbols) may be applied to continuous N slots. The terminal apparatus 1 may repeatedly transmit the transport block over continuous N slots starting with the slot in which the PUSCH is first transmitted. The terminal apparatus 1 may repeatedly transmit the transport block by using the same symbol allocation in each slot. The slot aggregation transmission performed by the terminal apparatus 1 in a case that the higher layer parameter pusch-AggregationFactor is configured may be referred to as a first slot aggregation transmission. In other words, the higher layer parameter pusch-AggregationFactor is used to indicate the number of repetitions of the first slot aggregation transmission (repetition transmissions). The higher layer parameter pusch-AggregationFactor is also referred to as a first aggregation transmission parameter. Here, in the formula for specifying the slot, a Ceiling function may be utilized instead of the Floor function. A function Ceiling (A) outputs a minimum integer not less than A.

In the first aggregation transmission, the 0th transmission occasion may be in the slot in which the PUSCH is first transmitted. In this regard, the transmission occasion may be referred to as an uplink period (UL period). The 2nd transmission occasion may be in the slot next to the slot in which the PUSCH is first transmitted. The (N−1)th transmission occasion may be in the Nth slot from the slot in which the PUSCH is first transmitted. A Redundancy Version applied to transmission of a transport block may be determined based on the (n−1)th transmission occasion of the transport block and rv_{id} indicated by the DCI scheduling the PUSCH. A sequence of the redundancy versions is {0, 2, 3, 1}. The variable rv_{id} is an index to the sequence of the redundancy versions. The variable is updated by the variable modulo 4. The redundancy version is used for coding (rate matching) of the transport block transmitted on the PUSCH. The redundancy version may be incremented in the order of 0, 2, 3, and 1. The repetition transmission of the transport block may be performed in order of the Redundancy Version.

In a case that at least one symbol in the symbol allocation for a certain transmission occasion is indicated as a downlink symbol through a higher layer parameter, the terminal apparatus 1 need not transmit the transport block in a certain slot in the transmission occasion.

In the present embodiment, the base station apparatus 3 may transmit a higher layer parameter pusch-AggregationFactor-r16 to the terminal apparatus 1. The higher layer parameter pusch-AggregationFactor-r16 may be used to indicate the number of repetition transmissions of data (transport block). The higher layer parameter pusch-AggregationFactor-r16 may be used to indicate the number of repetitions of slot aggregation transmission and/or mini-slot aggregation transmission. The slot aggregation transmission and the mini-slot aggregation transmission will be described below.

In the present embodiment, pusch-AggregationFactor-r16 is configured with a value of one of n1, n2, and n3, for example. The values of n1, n2, and n3 may respectively be 2, 4, and 8, or may be other values. n1, n2, and n3 each indicate the number of repetition transmissions of the transport block. In other words, pusch-AggregationFactor-r16 may indicate one value of the number of repetition transmissions. The number of repetition transmissions of the transport block may be the number of repetition transmissions within the slot (such as Nᵣₑₚ), or the number of repetition transmissions both within the slot and between slots (such as Nₜₒₜₐₗ), or the number of repetition transmissions between slots (such as Nₜₒₜₐₗ). Alternatively, the base station apparatus 3 may transmit, to the terminal apparatus 1, pusch-AggregationFactor-r16 including more than one element such that the number of repetition transmissions can be more flexibly configured for the terminal apparatus 1. Each element (information element or entry) may be used to indicate the number of repetition transmissions of the transport block. In other words, pusch-AggregationFactor-r16 may indicate the number of multiple repetition transmissions being more than one. In the present embodiment, a second aggregation transmission may refer to the slot aggregation transmission performed by the terminal apparatus 1 in a case that the higher layer parameter pusch-AggregationFactor-r16 is configured. In other words, the higher layer parameter pusch-AggregationFactor-r16 may be used to indicate at least the number of repetitions of the second aggregation transmission. The higher layer parameter pusch-AggregationFactor-r16 is also referred to as a second aggregation transmission parameter. The base station apparatus 3 may indicate any of the elements through the field included in the DCI scheduling the transport block, and notify the terminal apparatus 1 of the number of repetition transmissions of the transport block. A specific procedure will be described below. Additionally, the base station apparatus 3 may indicate any of the elements via a MAC Control Element (MAC CE), and notify the terminal apparatus 1 of the number of repetition transmissions of the transport block. In other words, the base station apparatus 3 may indicate any of the elements via a field included in the DCI and/or the MAC CE, and dynamically notify the terminal apparatus 1 of the number of repetition transmissions. The application, to the terminal apparatus 1, of the function of the number of dynamic repetitions may mean that the terminal apparatus 1 is dynamically notified of the number of repetition transmissions by the base station apparatus 3.

As a first example, the base station apparatus 3 need not transmit pusch-AggregationFactor and pusch-AggregationFactor-r16 to the terminal apparatus 1. In other words, the terminal apparatus 1 need not be configured with pusch-AggregationFactor and pusch-AggregationFactor-r16. In other words, the terminal apparatus 1 may receive, from the base station apparatus 3, an RRC message not including (not configured with) pusch-AggregationFactor and pusch-AggregationFactor-r16. In this case, the terminal apparatus 1 may transmit the PUSCH in the slot given by (Expression 1) as described above. In other words, the number of repetition transmissions of the transport block may be one. In other words, the terminal apparatus 1 need not perform slot aggregation transmission and/or mini-slot aggregation transmission.

As a second example, the base station apparatus 3 may transmit pusch-AggregationFactor and need not transmit pusch-AggregationFactor-r16, to the terminal apparatus 1. In other words, for the terminal apparatus 1, pusch-AggregationFactor may be configured, whereas pusch-AggregationFactor-r16 need not be configured. In other words, the terminal apparatus 1 may receive, from the base station apparatus 3, an RRC message including (configured with) pusch-AggregationFactor and not including (not configured with) pusch-AggregationFactor-r16. In this case, the terminal apparatus 1 may transmit the PUSCH N times in continuous N slots starting with the slot given by (Expression 1) as described above. In other words, the number of repetition transmissions of the transport block may be N indicated by pusch-AggregationFactor. The terminal apparatus 1 may perform the first aggregation transmission on the PUSCH scheduled by the DCI. The same symbol allocation may be applied to continuous N slots.

As a third example, the base station apparatus 3 need not transmit pusch-AggregationFactor but may transmit pusch-AggregationFactor-r16, to the terminal apparatus 1. In other words, for the terminal apparatus 1, pusch-AggregationFactor need not be configured, whereas pusch-AggregationFactor-r16 may be configured. In other words, the terminal apparatus 1 may receive, from the base station apparatus 3, an RRC message not including (not configured with) pusch-AggregationFactor but including (configured with) pusch-AggregationFactor-r16. In this case, the terminal apparatus 1 may transmit the PUSCH M times in one or multiple slots from the slot given by (Expression 1) as described above. Unlike in the first aggregation transmission, multiple slots may be continuous or discontinuous. In other words, the number M of repetitions of the transport block may be indicated by pusch-AggregationFactor-r16. The same symbol allocation need not be applied to multiple slots. In other words, the PUSCH time domain resource allocation (symbol allocation) applied to the first repetition transmission of the transport block may be given based on the DCI scheduling the transport block. However, the PUSCH symbol allocation applied to the second and/or subsequent repetition transmissions of the transport block may be different from the symbol allocation given based on the PDCCH (such as DCI) that schedules the PUSCH. This is referred to as symbol allocation expansion. Specifically, the starting symbol S applied to the second and/or subsequent repetition transmissions of the transport block may be different from the starting symbol S given based on the PDCCH (starting symbol expansion). For example, the starting symbol S applied to the second and/or subsequent repetition transmissions of the transport block may be the 0th symbol at the beginning of the slot. Additionally, the starting symbol S applied to the second and/or subsequent repetition transmissions of the transport block may be the same as the starting symbol S given based on the PDCCH. For example, the starting symbol S applied to the second and/or subsequent repetition transmissions of the transport block may be the first available symbol following the beginning of the slot. Additionally, the number L of continuous allocated symbols of the PUSCH to be applied to the second and/or subsequent repetition transmissions of the transport block may be different from the number L of continuous allocated symbols given based on the PDCCH (symbol number expansion). The number L of continuous allocated symbols of the PUSCH to be applied to the second and/or subsequent repetition transmissions of the transport block may be the same as the number L of continuous allocated symbols given based on the PDCCH.

Additionally, as a fourth example, the base station apparatus 3 may transmit pusch-AggregationFactor and pusch-AggregationFactor-r16 to the terminal apparatus 1. In other words, the terminal apparatus 1 may be configured with pusch-AggregationFactor and pusch-AggregationFactor-r16. In other words, the terminal apparatus 1 may receive, from the base station apparatus 3, an RRC message including (configuring) pusch-AggregationFactor and pusch-AggregationFactor-r16. Basically, the function for symbol allocation expansion (starting symbol expansion and/or symbol number expansion), the number of dynamic repetitions, and/or mini-slot aggregation transmission is applied, the function corresponding to an operation performed in a case that pusch-AggregationFactor-r16 is configured as described as the third example.

In a case that the function provided in a case that the pusch-AggregationFactor-r16 is configured is not applied, as described above, the first aggregation transmission may be performed for the PUSCH transmission scheduled by the DCI in a case that pusch-AggregationFactor is configured. In other words, the terminal apparatus 1 may repeatedly transmit the transport block N times across N continuous slots. The value of N may be given by pusch-AggregationFactor. The same symbol allocation may be applied in the N slots. Additionally, in a case that the function provided in a case that the pusch-AggregationFactor-r16 is configured is not applied, the PUSCH transmission scheduled by the DCI may be performed once in a case that pusch-AggregationFactor is not configured. In other words, the terminal apparatus 1 may transmit the transport block once.

As described above, for the slot aggregation transmission (the slot aggregation transmission in the first aggregation transmission and the second aggregation transmission), one uplink grant may schedule two or more PUSCH repetition transmissions. Repetition transmissions are performed in the respective continuous slots (or respective available slots). In other words, in the slot aggregation, the maximum number of repetition transmissions of the same transport block within one slot (one available slot) is one only. The available slot may be a slot in which the repetition transmission of the transport block is actually performed.

In the mini-slot aggregation transmission, one uplink grant may schedule two or more PUSCH repetition transmissions. The repetition transmissions may be performed in the same slot or across continuous available slots. In the scheduled PUSCH repetition transmissions, each slot may have a different number of repetition transmissions performed in the slot, based on the symbols available for PUSCH repetition transmission in the slot (available slot). In other words, in the mini-slot aggregation transmission, the number of repetition transmissions of the same transport block within one slot (one available slot) may be one or more. In other words, in the mini-slot aggregation transmission, the terminal apparatus 1 can transmit one or more repetition transmissions of the same transport block to the base station apparatus 3 within one slot. In other words, it can also be said that the mini-slot aggregation transmission means a mode that supports intra-slot aggregation. The symbol allocation expansion (starting symbol expansion and/or symbol number expansion) and/or the number of dynamic repetitions described above may be applied to the mini-slot aggregation transmission.

In the present embodiment, the terminal apparatus 1 may determine, based at least on (I) a higher layer parameter and/or (II) a field included in the uplink grant, whether the aggregation transmission is applied to the PUSCH transmission for which the uplink grant is scheduled, or whether any of the aggregation transmission types is applied. The aggregation transmission type may include the first aggregation transmission and the second aggregation transmission. As another example, the second aggregation transmission may be divided into different types: slot aggregation transmission and mini-slot aggregation transmission. In other words, the types of aggregation transmission may include first slot aggregation transmission (first aggregation transmission), second slot aggregation transmission (slot aggregation in the second aggregation transmission), and the mini-slot aggregation transmission.

In Aspect A of the present embodiment, the base station apparatus 3 may notify, by the higher layer parameter, the terminal apparatus 1 of which of the slot aggregation transmission and the mini-slot aggregation transmission is configured. Which of the slot aggregation transmission and the mini-slot aggregation transmission is configured may mean which of the slot aggregation transmission and the mini-slot aggregation transmission is applied. For example, pusch-AggregationFactor may be used to indicate the number of repetitions of the first aggregation transmission (the first slot aggregation transmission). pusch-AggregationFactor-r16 may be used to indicate the number of repetitions of the second slot aggregation transmission and/or the mini-slot aggregation transmission. pusch-AggregationFactor-r16 may be a common parameter for the second slot aggregation transmission and/or the mini-slot aggregation transmission. A higher layer parameter repTxWithinSlot-r16 may be used to indicate mini-slot aggregation transmission. In a case that the higher layer parameter repTxWithinSlot-r16 is effectively set, the terminal apparatus 1 may consider that the mini-slot aggregation transmission is applied to transport block transmission, and may perform the mini-slot aggregation transmission. In other words, in a case that pusch-AggregationFactor-r16 is configured for the terminal apparatus 1 and repTxWithinSlot-r16 is configured (set effectively), the terminal apparatus 1 may consider that mini-slot aggregation transmission is applied. The number of repetitions of the mini-slot aggregation transmission may be indicated by pusch-AggregationFactor-r16. In a case that pusch-AggregationFactor-r16 is configured for the terminal apparatus 1 and repTxWithinSlot-r16 is not configured, the terminal apparatus 1 may consider that the second slot aggregation transmission is applied. The number of repetitions of the second slot aggregation transmission may be indicated by pusch-AggregationFactor-r16. Additionally, in a case that pusch-AggregationFactor is configured for the terminal apparatus 1 and pusch-AggregationFactor-r16 is not configured, the terminal apparatus 1 may consider that the first slot aggregation transmission is applied. Additionally, in a case that pusch-AggregationFactor and pusch-AggregationFactor-r16 are not configured for the terminal apparatus 1, the terminal apparatus 1 may consider that the aggregation transmission is not applied and may perform one transmission of the PUSCH for which the uplink grant is scheduled. In the present embodiment, configuring the higher layer parameter (e.g., repTxWithinSlot-r16) may mean that the higher layer parameter (e.g., repTxWithinSlot-r16) is validly set or that the higher layer parameter (e.g., repTxWithinSlot-r16) is transmitted from the base station apparatus 3. In the present embodiment, not configuring the higher layer parameter (e.g., repTxWithinSlot-r16) may mean that the higher layer parameter (e.g., repTxWithinSlot-r16) is invalidly configured or that the higher layer parameter (e.g., repTxWithinSlot-r16) is not transmitted from the base station apparatus 3.

In Aspect B of the present embodiment, the base station apparatus 3 may notify, by the higher layer parameter, the terminal apparatus 1 of which of the slot aggregation transmission and the mini-slot aggregation transmission is configured. pusch-AggregationFactor may be used to indicate the number of repetitions of the first slot aggregation transmission. pusch-AggregationFactor-r16 may be used to indicate the number of repetitions of the second slot aggregation transmission and/or the mini-slot aggregation transmission. pusch-AggregationFactor-r16 may be a common parameter for the second slot aggregation transmission and/or the mini-slot aggregation transmission. In a case that pusch-AggregationFactor-r16 is configured for the terminal apparatus 1, the second slot aggregation transmission and/or the mini-slot aggregation transmission may be applied to the terminal apparatus 1.

Next, the terminal apparatus 1 may determine which of the slot aggregation transmission and the mini-slot aggregation transmission is applied, based on the field included in the uplink grant scheduling PUSCH transmission (PUSCH repetition transmission). As an example, a certain field included in the uplink grant may be used to indicate which of the slot aggregation transmission and the mini-slot aggregation transmission is applied. The field may include one bit. Additionally, the terminal apparatus 1 may determine which of the slot aggregation transmission and the mini-slot aggregation transmission is applied, based on the field included in the uplink grant transmitted from the base station apparatus 3. The terminal apparatus 1 may determine that the slot aggregation transmission is applied in a case that the field indicates 0, and may determine that the mini-slot aggregation transmission is applied in a case that the field indicates 1.

As an example, the terminal apparatus 1 may determine which of the slot aggregation transmission and the mini-slot aggregation transmission is applied, based on the ‘Time domain resource assignment’ field included in the uplink grant transmitted from the base station apparatus 3. As described above, the ‘Time domain resource assignment’ field is used to indicate the PUSCH time domain resource allocation. The terminal apparatus 1 may determine which of the slot aggregation transmission and the mini-slot aggregation transmission is applied, based on whether the number L of continuous allocated symbols obtained based on the ‘Time domain resource assignment’ field exceeds a prescribed value. The terminal apparatus 1 may determine that the slot aggregation transmission is applied, in a case that the symbol number L exceeds a prescribed value. The terminal apparatus 1 may determine that the mini-slot aggregation transmission is applied, in a case that the symbol number L does not exceed the prescribed value. The prescribed value may be a value indicated by the higher layer parameter. The prescribed value may be a value defined in advance in specifications or the like. For example, the prescribed value may be seven symbols.

The terminal apparatus 1 may establish Nₜₒₜₐₗ. Nₜₒₜₐₗ is the total number (total number of PUSCHs repeatedly transmitted) of repetition transmissions of the same transport block scheduled by one uplink grant. In other words, Nₜₒₜₐₗ is the number of one or multiple PUSCHs scheduled by one uplink grant. The terminal apparatus 1 may establish Nᵣₑₚ. Nᵣₑₚ is the number of repetition transmissions of the same transport block within the slot (number of PUSCHs repeatedly transmitted). In other words, Nᵣₑₚ is, for one or multiple PUSCHs scheduled by one uplink grant, the number of one or multiple PUSCHs allocated in a certain slot. The terminal apparatus 1 may establish Nₛₗₒₜₛ. Nₛₗₒₜₛ is the number of slots in which the same transport block scheduled by one uplink grant is repeatedly transmitted. In other words, Nₛₗₒₜₛ is the number of slots used for one or multiple PUSCHs scheduled by one uplink grant. The terminal apparatus 1 may derive Nₜₒₜₐₗ from Nᵣₑₚ and Nₛₗₒₜₛ. The terminal apparatus 1 may derive Nᵣₑₚ from Nₜₒₜₐₗ and Nₛₗₒₜₛ. The terminal apparatus 1 may derive Nₛₗₒₜₛ from Nᵣₑₚ and Nₜₒₜₐₗ. Nₛₗₒₜₛ may be one or two. Nᵣₑₚ may have a value varying among the slots. Nᵣₑₚ may have the same value among the slots.

A higher layer parameter frequencyHopping may be configured (provided) for the terminal apparatus 1. The higher layer parameter frequencyHopping may be set to one of ‘intraSlot’ and ‘interSlot’. In a case that frequencyHopping is set to ‘intraSlot’, the terminal apparatus 1 may transmit the PUSCH with intra-slot frequency hopping. In other words, configuring the intra-slot frequency hopping for the terminal apparatus 1 may mean that frequencyHopping is set to ‘intraSlot’ and that the ‘Frequency hopping flag’ field included in the DCI scheduling the PUSCH has a value set to 1. In a case that frequencyHopping is set to ‘interSlot’, the terminal apparatus 1 may transmit the PUSCH with inter-slot frequency hopping. In other words, configuring the inter-slot frequency hopping for the terminal apparatus 1 may mean that the frequencyHopping is set to ‘interSlot’ and that the ‘Frequency hopping flag’ field included in the DCI scheduling the PUSCH has a value set to 1. Additionally, in a case that the base station apparatus 3 does not transmit frequencyHopping to the terminal apparatus 1, the terminal apparatus 1 may perform the PUSCH transmission without frequency hopping. In other words, the lack of configuration of frequency hopping for the terminal apparatus 1 may include the lack of transmission of frequencyHopping. Additionally, the lack of configuration of frequency hopping for the terminal apparatus 1 may include setting, to 0, of the value of the ‘Frequency hopping flag’ field included in the DCI scheduling the PUSCH despite transmission of frequencyHopping.

In the uplink transmission of the present embodiment, the available symbols may be symbols indicated as flexible and/or uplink by at least a higher layer parameter TDD-UL-DL-ConfigurationCommon and/or TDD-UL-DL-ConfigDedicated. In other words, the available symbols are not symbols indicated as downlink by the higher layer parameter TDD-UL-DL-ConfigurationCommon and/or TDD-UL-DL-ConfigDedicated. The higher layer parameter TDD-UL-DL-ConfigurationCommon and/or TDD-UL-DL-ConfigDedicated is used to establish an uplink/downlink TDD configuration. However, the available symbols are not symbols indicated by at least a higher layer parameter ssb-PositionsInBurst. ssb-PositionsInBurst is used to indicate the time domain position of the SS/PBCH block transmitted to the base station apparatus 3. In other words, the terminal apparatus 1 recognizes the position of the symbol in which the SS/PBCH block is transmitted by ssb-PositionsInBurst. The symbol in which the SS/PBCH block is transmitted may be referred to as an SS/PBCH block symbol. In other words, the available symbols are not SS/PBCH block symbols. However, the available symbols are at least not symbols indicated by pdcch-ConfigSIB1. In other words, the available symbols are not symbols indicated by pdcch-ConfigSIB1 for the CORESET for the Type0-PDCCH common search space set. pdcch-ConfigSIB1 may be included in the MIB or ServingCellConfigCommon.

The terminal apparatus 1 may receive, from the base station apparatus 3, configurations and/or indications related to spatial relation information to be applied to PUSCH transmission (PUSCH repetition transmission). A more specific description will be given below.

As a first example, in a case of using higher parameters for configurations and/or indications related to one or multiple pieces of spatial relation information received from the base station apparatus and receiving uplink grant including an SRI field, the terminal apparatus 1 may determine spatial relation information to be applied to the nth repeated transmission of a transport block as spatial relation information configured for an SRS resource defined as (SRI_{d}+n) mod Nₛᵣₛ. The function (A) mod (B) executes division of A and B, and outputs a number for a remainder resulting from the division. Here, SRI_{d} indicates an SRI notified by the uplink grant, and Nₛᵣₛ indicates the total number of SRS resources configured for the terminal apparatus 1. In addition to the case of receiving the uplink grant including the SRI field, in a case of having received no configuration of a higher layer parameter rrc-ConfiguredUplinkGrant but receiving, from the base station apparatus, a higher layer parameter ConfiguredGrantConfig including the SRI field (srs-ResourceIndicator), the terminal apparatus 1 may determine the spatial relation information to be applied to the nth repeated transmission of the transport block as spatial relation information configured for the SRS resource defined as (SRI_{d}+n) mod Nₛᵣₛ.

As a second example, in a case of using the higher parameters for the configurations and/or indications related to one or multiple pieces of spatial relation information received from the base station apparatus and receiving an uplink grant not including the SRI field, the terminal apparatus 1 may determine the spatial relation information to be applied to the nth repeated transmission of the transport block as spatial relation information (PUCCH-SpatialRelationInfo) defined as (PUCCHₛₚₐₜᵢₐₗᵣₑₗₐₜᵢₒₙ+n) mod Nₛₚₐₜᵢₐₗᵣₑₗₐₜᵢₒₙ. Here, the PUCCHₛₚₐₜᵢₐₗᵣₑₗₐₜᵢₒₙ indicates spatial relation information associated with one of the one or multiple PUCCH resources configured by the base station apparatus 3 with the smallest ID, and Nₛₚₐₜᵢₐₗᵣₑₗₐₜᵢₒₙ indicates the total number of PUCCH-SpatialRelationInfo configured for the terminal apparatus 1. Additionally, in addition to the case of receiving the uplink grant not including the SRI field, in a case of receiving a configuration of the higher layer parameter rrc-ConfiguredUplinkGrant, and/or in a case of receiving, from the base station apparatus, the higher layer parameter ConfiguredGrantConfig not including the SRI field (srs-ResourceIndicator), the terminal apparatus 1 may determine the spatial relation information to be applied to the nth repeated transmission of the transport block as spatial relation information (PUCCH-SpatialRelationInfo) defined as (PUCCHₛₚₐₜᵢₐₗᵣₑₗₐₜᵢₒₙ+n) mod Nₛₚₐₜᵢₐₗᵣₑₗₐₜᵢₒₙ.

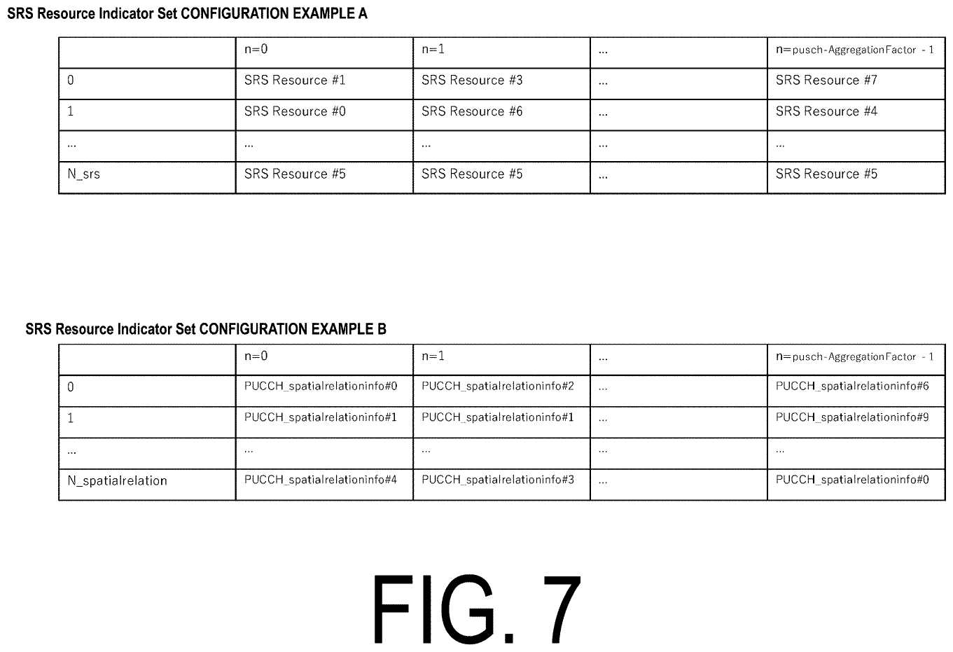

As a third example, in a case of using the higher parameters for the configurations and/or indications related to one or multiple pieces of spatial relation information received from the base station apparatus and receiving an uplink grant including, as a higher parameter, an SRS Resource Indicator Set corresponding to the nth repeated transmission of the transport block and not including the SRI field, the terminal apparatus 1 may determine the spatial relation information to be applied to the nth repeated transmission of the transport block as spatial relation information configured for the SRS resource defined by the configuration information regarding the SRS Resource Indicator Set. Additionally, as illustrated in SRS Resource Indicator Set configuration example A in FIG. 7, the SRS Resource Indicator Set configuration may be configured as a table of the total number of SRI resources and the size of pusch-AggregationFactor. In a case of receiving the uplink grant not including the SRI field, the terminal apparatus may determine the spatial relation information to be applied to the nth repeated transmission of the transport block as spatial relation information configured for the SRS resource defined by a combination of a value indicated by a prescribed SRI field and the number of repeated transmissions of the transport block, the value and the number being included in the table. Additionally, in addition to the case of receiving the uplink grant not including the SRI field, in a case of receiving the configuration of the higher layer parameter rrc-ConfiguredUplinkGrant and/or in a case of receiving, from the base station apparatus, the higher layer parameter ConfiguredGrantConfig not including the SRI field (srs-ResourceIndicator), the terminal apparatus 1 may determine, based on the table, the spatial relation information as spatial relation information configured for the SRS resource defined by a combination of the value indicated by the prescribed SRI field and the number of repeated transmissions of the transport block. Here, the value indicated by the prescribed SRI field may be a value predefined in specifications or a value received by the terminal apparatus 1 as a higher parameter from the base station apparatus.

As a fourth example, in a case of using the higher parameters for the configurations and/or indications related to one or multiple pieces of spatial relation information received from the base station apparatus and receiving an uplink grant including, as a higher parameter, the SRS Resource Indicator Set corresponding to the nth repeated transmission of the transport block and not including the SRI field, the terminal apparatus 1 may determine the spatial relation information to be applied to the nth repeated transmission of the transport block as spatial relation information (PUCCH-SpatialRelationInfo) defined by the configuration information regarding the SRS Resource Indicator Set. Additionally, as illustrated in SRS Resource Indicator Set configuration example B in FIG. 7, the SRS Resource Indicator Set configuration may be provided as a table of the total number of PUCCH-SpatialRelationInfo and the size of pusch-AggregationFactor. In a case of receiving the uplink grant not including the SRI field, the terminal apparatus 1 may determine the spatial relation information to be applied to the nth repeated transmission of the transport block as spatial relation information (PUCCH-SpatialRelationInfo) defined by a combination of a value indicated by a prescribed SRI field and the number of repeated transmissions of the transport block, the value and the number being included in the table. Additionally, in addition to the case of receiving the uplink grant not including the SRI field, in a case of receiving the configuration of the higher layer parameter rrc-ConfiguredUplinkGrant and/or in a case of receiving, from the base station apparatus, the higher layer parameter ConfiguredGrantConfig not including the SRI field (srs-ResourceIndicator), the terminal apparatus 1 may determine, based on the table, the spatial relation information as spatial relation information configured for the SRS resource defined by a combination of the value indicated by the prescribed SRI field and the number of repeated transmissions of the transport block. Here, the value indicated by the prescribed SRI field may be a value predefined in specifications or a value received by the terminal apparatus 1 as a higher parameter from the base station apparatus.

Thus, the terminal apparatus 1 can transmit uplink data to the base station apparatus 3.

Now, a downlink path loss reference will be described that is used for transmit power for the uplink physical channel and/or the sounding reference signal according to the present embodiment.

Note that TPC accumulation may refer to the application, to the transmit power, of a power adjustment control value obtained by accumulatively calculating correction values obtained from the TPC command received by the terminal apparatus 1. Additionally, TPC absolute may refer to the terminal apparatus 1 using one last received correction value for the transmit power as a power control adjustment value instead of accumulatively calculating the correction values obtained from the TPC command

The downlink path loss may be calculated by the terminal apparatus 1, based on the transmit power (transmit power of the base station apparatus 3) for the (downlink) path loss reference (e.g., SS/PBCH block or CSI-RS) and the RSRP (measurement result for the path loss reference at the terminal apparatus 1). Here, the path loss reference may be a downlink reference signal (for example, an SS block or a CSI-RS) used as a measurement object for the RSRP used for calculation of path loss in the terminal apparatus 1 configured by the base station apparatus 3.

The terminal apparatus 1 and the base station apparatus 3 may communicate with no dedicated higher layer configuration being transmitted to the terminal apparatus 1 from the base station apparatus 3. The dedicated higher layer configuration may include zero, one, or multiple of a set of reference signals to be used for a PUSCH path loss estimation, a set of reference signals to be used for a PUCCH path loss estimation, and a set of reference signals to be used for an SRS path loss estimation.

The base station apparatus 3 may transmit a higher layer configuration pathlossReferenceRSToAddModList to the terminal apparatus 1. pathlossReferenceRSToAddModList indicates a set of reference signals to be used for the PUSCH path loss estimation. This parameter corresponds to a path loss reference to be applied to the transmission of the PUSCH described below. The terminal apparatus 1 may receive a higher layer configuration pathlossReferenceRSToAddModList from the base station apparatus 3.

The base station apparatus 3 may transmit, to the terminal apparatus 1, a higher layer configuration pathlossReferenceRS included in the PUCCH configuration information. pathlossReferenceRS included in the PUCCH configuration information indicates a set of reference signals to be used for the PUCCH path loss estimation. This parameter corresponds to a path loss reference to be applied to the transmission of the PUCCH described below. The terminal apparatus 1 may receive, from the base station apparatus 3, a higher layer configuration pathlossReferenceRS included in the PUCCH configuration information.

The base station apparatus 3 may transmit, to the terminal apparatus 1, the higher layer configuration pathlossReferenceRS included in the SRS configuration information. pathlossReferenceRS included in the SRS configuration information indicates a set of reference signals to be used for the SRS path loss estimation. This parameter corresponds to a path loss reference applied to the transmission of the SRS as described below. The terminal apparatus 1 may receive, from the base station apparatus 3, the higher layer configuration of pathlossReferenceRS included in the SRS configuration information.

In a case that for the path loss reference to be applied to the transmission of the PUSCH by the terminal apparatus 1, the configuration of multiple SS blocks and/or the configuration of CSI-RSs is indicated by the base station apparatus 3 through higher layer signaling (RRC message and/or MAC CE), the information indicating the path loss reference may be information indicating a path loss reference associated with an SRS transmission resource indicated by SRI information indicated to the terminal apparatus 1 in the uplink grant by the base station apparatus 3, or the configuration of multiple SS blocks and/or the configuration of CSI-RSs indicated by the base station apparatus 3 through higher layer signaling, with the ID configured as zero, information indicating a path loss reference associated with one of one or multiple PUCCH resources configured by the base station apparatus 3, the one PUCCH resource having the minimum ID, or information indicating a path loss reference included in the random access response (for example, a reference signal applied as a path loss reference during transmission of message 1 by the terminal apparatus 1). Additionally, in a case that the base station apparatus 3 does not indicate the configuration of SS blocks and/or the configuration of CSI-RSs to the terminal apparatus 1 through the higher layer signaling, the information indicating the path loss reference may be a reference signal (SS block and/or CSI-RS) specified by the terminal apparatus 1 through the random access procedure. In this regard, the random access procedure may be initiated due to a specific factor. For example, in a case that the terminal apparatus 1 is not provided by the base station apparatus 3 with a path loss reference to be applied to the transmission of the PUSCH or before the terminal apparatus 1 is provided with a dedicated higher layer configuration by the base station apparatus 3, the terminal apparatus 1 may calculate a downlink path loss estimation by using a resource for a reference signal from the SS/PBCH block selected by the terminal apparatus 1 through a recently generated random access procedure that has not been initiated on the PDCCH order that triggers the non-contention based random access procedure. The above-described processing may be performed by the terminal apparatus 1 in a case that the downlink path loss estimation used for the transmit power control to be applied to the transmission of the PUSCH is configured by the higher layer to be calculated by using a downlink reference signal with an activated BWP. The base station apparatus 3 may perform power control, based on the assumption that the above-described processing is performed by the terminal apparatus 1. Additionally, the base station apparatus 3 may transmit the higher layer configuration such that the above-described processing is performed by the terminal apparatus 1.

In a case that for the path loss reference to be applied to the transmission of the PUCCH by the terminal apparatus 1, the configuration of multiple SS blocks and/or the configuration of CSI-RSs is indicated by the base station apparatus 3 through higher layer signaling (RRC message and/or MAC CE), the information indicating the path loss reference may be information indicating a path loss reference associated with a PUCCH resource for the terminal apparatus 1 by the base station apparatus 3, or the configuration of multiple SS blocks and/or the configuration of CSI-RSs indicated by the base station apparatus 3 through higher layer signaling, with the ID configured as zero, or information indicating a path loss reference associated with one of one or multiple PUCCH resources that has the minimum ID, for a cell configured to be associated with a path loss reference by the base station apparatus 3 through higher layer signaling. Additionally, in a case that the base station apparatus 3 does not indicate the configuration of SS blocks and/or the configuration of CSI-RSs to the terminal apparatus 1 through the higher layer signaling, the information indicating the path loss reference may be a reference signal (SS block and/or CSI-RS) specified by the terminal apparatus 1 through the random access procedure. In this regard, the random access procedure may be initiated due to a specific factor. For example, in a case that the terminal apparatus 1 is not provided by the base station apparatus 3 with a path loss reference to be applied to the transmission of the PUCCH or before the terminal apparatus 1 is provided with a dedicated higher layer configuration by the base station apparatus 3, the terminal apparatus 1 may calculate a downlink path loss estimation by using a resource for a reference signal from the SS/PBCH block selected by the terminal apparatus 1 through a recently generated random access procedure that has not been initiated on the PDCCH order that triggers the non-contention based random access procedure. The above-described processing may be performed by the terminal apparatus 1 in a case that the downlink path loss estimation used for the transmit power control to be applied to the transmission of the PUCCH is configured by the higher layer to be calculated by using a downlink reference signal with an activated BWP. The base station apparatus 3 may perform power control, based on the assumption that the above-described processing is performed by the terminal apparatus 1. Additionally, the base station apparatus 3 may transmit the higher layer configuration such that the above-described processing is performed by the terminal apparatus 1.

In a case that for the path loss reference to be applied to the transmission of the SRS by the terminal apparatus 1, the configuration of multiple SS blocks and/or the configuration of CSI-RSs is indicated by the base station apparatus 3 through higher layer signaling (RRC message and/or MAC CE), the information indicating the path loss reference may be information indicating a path loss reference associated with a resource for SRS transmission for the terminal apparatus 1 by the base station apparatus 3, or information indicating a path loss reference for a cell configured with a path loss reference association associated with a resource for SRS transmission through higher layer signaling by the base station apparatus 3. Additionally, in a case that the base station apparatus 3 does not indicate the configuration of SS blocks and/or the configuration of CSI-RSs to the terminal apparatus 1 through the higher layer signaling, the information indicating the path loss reference may be a reference signal (SS block and/or CSI-RS) specified by the terminal apparatus 1 through the random access procedure. In this regard, the random access procedure may be initiated due to a specific factor. For example, in a case that the terminal apparatus 1 is not provided by the base station apparatus 3 with a path loss reference to be applied to the transmission of the SRS or before the terminal apparatus 1 is provided with a dedicated higher layer configuration by the base station apparatus 3, the terminal apparatus 1 may calculate a downlink path loss estimation by using a resource for a reference signal from the SS/PBCH block selected by the terminal apparatus 1 through a recently generated random access procedure that has not been initiated on the PDCCH order that triggers the non-contention based random access procedure. The above-described processing may be performed by the terminal apparatus 1 in a case that the downlink path loss estimation used for the transmit power control to be applied to the transmission of the SRS is configured by the higher layer to be calculated by using a downlink reference signal with an activated BWP. The base station apparatus 3 may perform power control, based on the assumption that the above-described processing is performed by the terminal apparatus 1. Additionally, the base station apparatus 3 may transmit the higher layer configuration such that the above-described processing is performed by the terminal apparatus 1.

The transmit power for the PUSCH and message 3 used by the terminal apparatus 1 is set based on a subcarrier spacing configuration μ, a bandwidth allocated to the PUSCH (the number of resource blocks), reference power for the PUSCH, terminal apparatus-specific power for the PUSCH, a power offset based on a PUSCH modulation scheme, and a compensation coefficient for downlink path loss, the downlink path loss, and a correction value for a TPC command for the PUSCH. Note that the subcarrier spacing configuration μ, the reference power for the PUSCH, the terminal apparatus-specific power for the PUSCH, and the compensation coefficient for the downlink path loss are configured by the base station apparatus 3 as higher layer configurations. The higher layer configurations may be provided for the terminal apparatus 1 for each type of uplink grant, for each cell, and for each uplink subframe set by the base station apparatus 3.

The transmit power is set for the PUCCH used by the terminal apparatus 1, based on the subcarrier spacing configuration μ, a bandwidth allocated to the PUCCH (the number of resource blocks), reference power for the PUCCH, terminal apparatus-specific power for the PUCCH, a compensation coefficient for downlink path loss, a power offset based on a PUCCH format, the downlink path loss, and a correction value for a TPC command for the PUCCH. Note that the subcarrier spacing configuration μ, the reference power for the PUCCH, the terminal apparatus-specific power for the PUCCH, the power offset based on the PUCCH format, and the compensation coefficient for the downlink path loss are configured by the base station apparatus 3 as higher layer configurations. Additionally, the higher layer configurations may be provided for the terminal apparatus 1 for each cell group by the base station apparatus 3.

The transmit power for the SRS used by the terminal apparatus 1 is set on based on the subcarrier spacing configuration μ, the bandwidth allocated to the SRS (the number of resource blocks), reference power for the SRS, and the compensation coefficient for the downlink path loss, the downlink path loss, and a correction value for a TPC command for the SRS. Note that the subcarrier spacing configuration μ, the reference power for the SRS, and the compensation coefficient for the downlink path loss are configured by the base station apparatus 3 as higher layer configurations. The higher layer configurations may be provided for the terminal apparatus 1 for each type of uplink grant, for each cell, and for each uplink subframe set by the base station apparatus 3.

The terminal apparatus 1 may receive, from the base station apparatus 3, configurations and/or indications related to a path loss reference to be applied to the PUSCH repetition transmission. A more specific description will be given below.

As a first example, in a case of using higher parameters for configurations and/or indications related to a path loss reference received from the base station apparatus and receiving an uplink grant including the SRI field, the terminal apparatus 1 may determine a path loss reference to be applied to the nth repeated transmission of a transport block as a path loss reference defined as (q_{d, sri}+n) mod N_{qd}. In this regard, q_{d, sri} indicates PUSCH-PathlossReferenceRs-Id configured in association with the SRI notified by the uplink grant, and N_{q}d indicates the total number of PUSCH-PathlossReferenceRs configured for the terminal apparatus 1. Additionally, in addition to the case of receiving an uplink grant including the SRI field, in a case of not having received the configuration of the higher layer parameter rrc-ConfiguredUplinkGrant but receiving, from the base station apparatus, the higher layer parameter ConfiguredGrantConfig including the SRI field (srs-ResourceIndicator), the terminal apparatus 1 may determine a path loss reference to be applied to the nth repeated transmission of the transport block as a path loss reference defined as (q_{d, sri}+n) mod N_{qd}. Additionally, in a modification of the first example, in a case of receiving the uplink grant including the SRI field, the terminal apparatus 1 may determine the path loss reference to be applied to the transport block repeatedly transmitted N times as q_{d, sri} regardless of n. In yet another modification, in a case that mini-slot aggregation transmission is applied, the value of n may be the same among the slots within the same slot, and the value of n may be increased during repetition transmissions across slot boundaries.

As a second example, in a case of using the higher parameters for the configurations and/or indications related to the path loss reference received from the base station apparatus and receiving the uplink grant not including the SRI field, and/or in a case of not being configured by the base station apparatus with configuration information SRI-PUSCH-PowerControl related to the transmit power for the SRI and the PUSCH, and/or in a case of not being configured with PUCCH spatial relation information PUCCH-SpatialRelationInfo, the terminal apparatus 1 may determine the path loss reference to be applied to the nth repeated transmission of the transport block, as a path loss reference with PUSCH-PathlossReferenceRs-Id defined as n mod N_{qd}. Additionally, in addition to the case of receiving an uplink grant including the SRI field, in a case of receiving the configuration of the higher layer parameter rrc-ConfiguredUplinkGrant, and/or in a case of receiving, from the base station apparatus, the higher layer parameter ConfiguredGrantConfig not including the SRI field (srs-ResourceIndicator), the terminal apparatus 1 may determine the path loss reference to be applied to the nth repeated transmission of the transport block, as a path loss reference defined as n mod N_{qd}. Additionally, in a modification of the second example, in a case of receiving the uplink grant not including the SRI field, and/or in a case of not being configured by the base station apparatus with the configuration information SRI-PUSCH-PowerControl related to the transmit power for the SRI and the PUSCH, and/or in a case of not being configured with the PUCCH spatial relation information PUCCH-SpatialRelationInfo, the terminal apparatus 1 may determine that for the path loss reference to be applied to the N repeated transmissions of the transport block, PUSCH-PathlossReferenceRs-Id is zero regardless of n. In yet another modification, in a case that mini-slot aggregation transmission is applied, the value of n may be the same among the slots within the same slot, and the value of n may be increased during repetition transmissions across slot boundaries.

As a third example, in a case of using the higher parameters for the configurations and/or indications related to the path loss reference received from the base station apparatus and receiving the uplink grant not including the SRI field, and/or in a case of being configured with PUCCH spatial relation information PUCCH-SpatialRelationInfo, the terminal apparatus 1 may determine the path loss reference to be applied to the nth repeated transmission of the transport block, as a path loss reference configured with PUCCH-SpatialRelationInfo defined as (PUCCHₛₚₐₜᵢₐₗᵣₑₗₐₜᵢₒₙ+n) mod Nₛₚₐₜᵢₐₗᵣₑₗₐₜᵢₒₙ. Additionally, in addition to the case of receiving the uplink grant including the SRI field, in a case of receiving the configuration of the higher layer parameter rrc-ConfiguredUplinkGrant, and/or in a case of receiving, from the base station apparatus, the higher layer parameter ConfiguredGrantConfig not including the SRI field (srs-ResourceIndicator), the terminal apparatus 1 may determine the path loss reference to be applied to the nth repeated transmission of the transport block, as a path loss reference configured with PUCCH-SpatialRelationInfo defined as (PUCCHₛₚₐₜᵢₐₗᵣₑₗₐₜᵢₒₙ+n) mod Nₛₚₐₜᵢₐₗᵣₑₗₐₜᵢₒₙ. Additionally, in a modification of the third example, in a case that the terminal apparatus 1 is, in a case of receiving the uplink grant not including the SRI field, configured with the PUCCH spatial relation information PUCCH-SpatialRelationInfo, the terminal apparatus 1 may determine the path loss reference to be applied to the N repeated transmissions of the transport block, as PUCCHₛₚₐₜᵢₐₗᵣₑₗₐₜᵢₒₙ regardless of n. In yet another modification, in a case that mini-slot aggregation transmission is applied, the value of n may be the same among the slots within the same slot, and the value of n may be increased during repetition transmissions across slot boundaries.

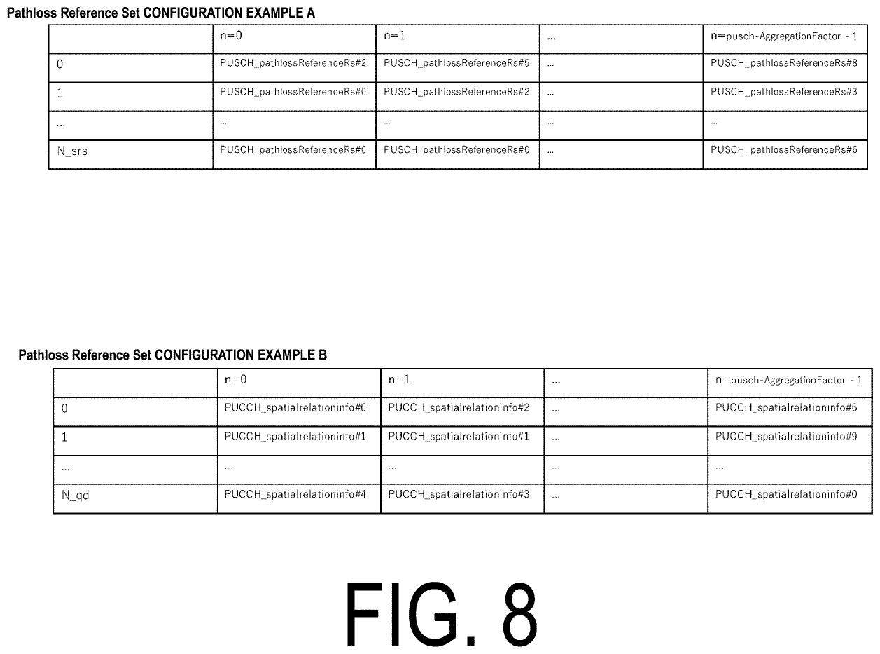

As a fourth example, in a case of using the higher parameters for the configurations and/or indications related to the path loss reference received from the base station apparatus and receiving an uplink grant including, as a higher layer parameter, a Pathloss Reference Set corresponding to the nth repeated transmission of the transport block and not including the SRI field as a higher layer parameter, the terminal apparatus 1 may determine the path loss reference to be applied to the nth repeated transmission of the transport block, as a path loss reference defined by configuration information of Pathloss Reference Set. Additionally, as illustrated in Pathloss Reference Set configuration example A in FIG. 8, the Pathloss Reference Set configuration may be configured as a table of the total number of SRI resources and the size of pusch-AggregationFactor, and in a case of receiving the uplink grant not including the SRI field, the terminal apparatus may determine, based on the table, the path loss reference to be applied to the nth repeated transmission of the transport block, as a path loss reference defined by a combination of a value indicated by a prescribed SRI field and a number n of repetition transmissions of the transport block. Additionally, in addition to the case of receiving the uplink grant not including the SRI field, in a case of receiving the configuration of the higher layer parameter rrc-ConfiguredUplinkGrant and/or in a case of receiving, from the base station apparatus, the higher layer parameter ConfiguredGrantConfig not including the SRI field (srs-ResourceIndicator), the terminal apparatus 1 may determine, based on the table, the path loss reference to be applied to the nth repeated transmission of the transport block, as a path loss reference defined by a combination of a value indicated by a prescribed SRI field and the number n of repetition transmissions of the transport block. Here, the value indicated by the prescribed SRI field may be a value predefined in specifications or a value received by the terminal apparatus 1 as a higher parameter from the base station apparatus.

As a fifth example, in a case of using the higher parameters for the configurations and/or indications related to the path loss reference received from the base station apparatus and receiving the uplink grant including, as a higher layer parameter, the Pathloss Reference Set corresponding to the nth repeated transmission of the transport block and not including the SRI field, the terminal apparatus 1 may determine the path loss reference to be applied to the nth repeated transmission of the transport block, as a path loss reference configured in the spatial relation information (PUCCH-SpatialRelationInfo), based on the configuration information of Pathloss Reference Set. Additionally, as illustrated in SRS Resource Indicator Set configuration example B in FIG. 8, the Pathloss Reference Set configuration may be configured as a table of the total number of PUCCH-SpatialRelationInfo and the size of pusch-AggregationFactor, and in a case of receiving the uplink grant not including the SRI field, the terminal apparatus may determine, based on the table, the spatial relation information to be applied to the nth repeated transmission of the transport block, as a path loss reference configured in spatial relation information (PUCCH-SpatialRelationInfo) defined by a combination of the value indicated by the prescribed SRI field and the number n of repetition transmissions of the transport block. Additionally, in addition to the case of receiving the uplink grant not including the SRI field, in a case of receiving the configuration of the higher layer parameter rrc-ConfiguredUplinkGrant and/or in a case of receiving, from the base station apparatus, the higher layer parameter ConfiguredGrantConfig not including the SRI field (srs-ResourceIndicator), the terminal apparatus 1 may determine, based on the table, the path loss reference to be applied to the nth repeated transmission of the transport block, as a path loss reference defined by a combination of a value indicated by a prescribed SRI field and the number n of repetition transmissions of the transport block. Here, the value indicated by the prescribed SRI field may be a value predefined in specifications or a value received by the terminal apparatus 1 as a higher parameter from the base station apparatus.

Note that the information related to the path loss reference may be information indicating a path loss reference for the cell, or may be information indicating a path loss reference for a cell configured with a path loss reference association associated through higher layer signaling by the base station apparatus 3.

The power for the PUSCH, the PUCCH, and the SRS is adjusted by the terminal apparatus 1, based on TPC commands corresponding to the respective physical channels.

The TPC accumulation may be configured for the terminal apparatus 1 for each cell, for each physical channel, for each subframe set, or for each SRS resource set by the base station apparatus 3. Additionally, the terminal apparatus 1 may use the TPC accumulation for the PUSCH as the TPC accumulation for the SRS.

As described above, the terminal apparatus 1 can appropriately set the uplink transmit power, based on the path loss reference. In yet another modification, in a case that one or multiple sPUSCH-PathlossReferenceRs are configured, an average value for path loss may be applied that is calculated by using the configured Rs, or a minimum or maximum path loss may be applied.

Configurations of apparatuses according to the present embodiment will be described below.

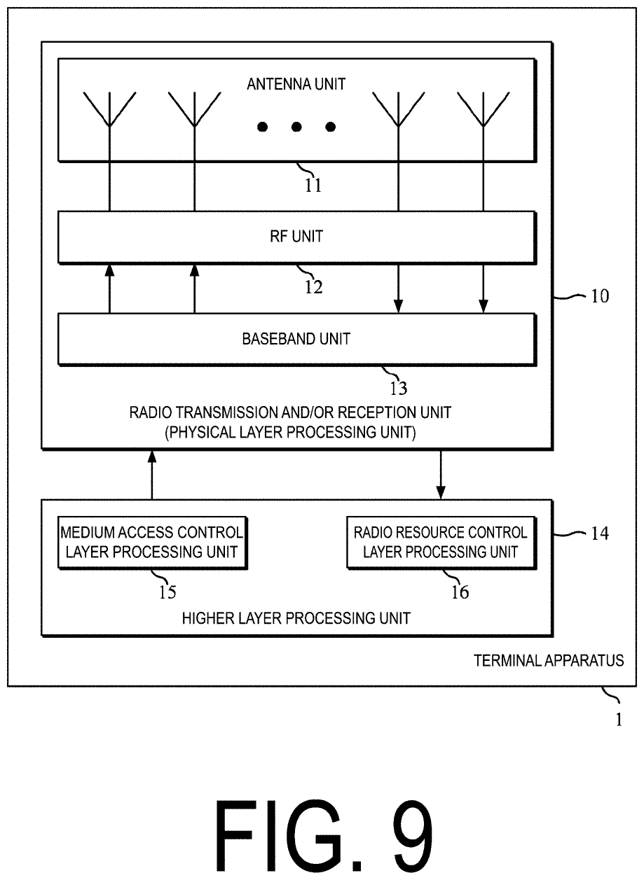

FIG. 9 is a schematic block diagram illustrating a configuration of the terminal apparatus 1 according to the present embodiment. As illustrated, the terminal apparatus 1 is configured to include a radio transmission and/or reception unit 10 and a higher layer processing unit 14. The radio transmission and/or reception unit 10 is configured to include an antenna unit 11, a Radio Frequency (RF) unit 12, and a baseband unit 13. The higher layer processing unit 14 includes a medium access control layer processing unit 15 and a radio resource control layer processing unit 16. The radio transmission and/or reception unit 10 is also referred to as a transmitter, a receiver, a monitor unit, or a physical layer processing unit. The higher layer processing unit 14 is also referred to as a measurement unit, a selection unit, or a control unit.

The higher layer processing unit 14 outputs uplink data (that may be referred to as transport block) generated by a user operation or the like, to the radio transmission and/or reception unit 10. The higher layer processing unit 14 performs a part or all of the processing of the Medium Access Control (MAC) layer, the Packet Data Convergence Protocol (PDCP) layer, the Radio Link Control (RLC) layer, and the Radio Resource Control (RRC) layer. The higher layer processing unit 14 may function to determine whether to repeatedly transmit the transport block, based on higher layer signaling received from the base station apparatus 3. The higher layer processing unit 14 may determine, based on the higher layer signaling received from the base station apparatus 3, whether to perform the first aggregation transmission and/or the second aggregation transmission. The higher layer processing unit 14 may function to control the symbol allocation expansion (starting symbol expansion and/or symbol number expansion), the number of dynamic repetitions, and/or the mini-slot aggregation transmission for the aggregation transmission (the second aggregation transmission), based on the higher layer signaling received from the base station apparatus 3. The higher layer processing unit 14 may determine whether to perform the frequency hopping transmission of the transport block, based on the higher layer signaling received from the base station apparatus 3. The higher layer processing unit 14 may output frequency hopping information, aggregation transmission information, and the like to the radio transmission and/or reception unit 10. The higher layer processing unit 14 may function to select one reference signal from one or multiple reference signals, based on measurement values for the respective reference signals. The higher layer processing unit 14 may function to select, from one or multiple PRACH occasions, a PRACH occasion associated with the one selected reference signal. The higher layer processing unit 14 may function to specify one index from one or multiple indexes configured by a higher layer (e.g., an RRC layer) and to set the index being a preamble index in a case that the bit information included in the information received by the radio transmission and/or reception unit 10 and indicating the initiation of the random access procedure is a prescribed value. The higher layer processing unit 14 may function to specify an index that is included in one or multiple indexes configured by RRC and that is associated with the selected reference signal and to set the index being the preamble index. The higher layer processing unit 14 may function to determine a next available PRACH occasion, based on the received information (e.g., SSB index information and/or mask index information). The higher layer processing unit 14 may function to select an SS/PBCH block, based on the received information (e.g., SSB index information). The higher layer processing unit may function to specify a reference for downlink path loss used for the transmit power for the uplink physical channel (PUSCH, PUCCH) and/or the sounding reference signal by using information indicating a path loss reference indicated by the higher layer signaling and/or SRI information indicated by the uplink grant (for example, information indicating a path loss reference associated with a resource for SRS transmission), and/or information regarding one or multiple configured PUCCH resources (for example, information indicating a path loss reference associated with a resource with the minimum ID), and/or information regarding a reference signal applied as a path loss reference during transmission of message 1, and/or information regarding a reference number specified through the random access procedure. The higher layer processing unit may function to specify the subcarrier spacing configuration μ, reference power for the uplink physical channel (PUSCH, PUCCH) and/or the sounding reference signal, and/or the terminal apparatus-specific power for the uplink physical channel (PUSCH, PUCCH) and/or the sounding reference signal, and the compensation coefficient for downlink path loss, which are configured by higher layer signaling. The higher layer processing unit 14 may function to control the second number, based on the higher layer signaling including the first number of repetition transmissions and/or the DCI field including the first number. The first number may be the number of repetition transmissions of the same transport block within a slot and across slots. The second number may be the number of repetition transmissions of the same transport block within a slot.

The medium access control layer processing unit 15 included in the higher layer processing unit 14 performs processing of the Medium Access Control layer (MAC layer). The medium access control layer processing unit 15 controls transmission of a scheduling request, based on various types of configuration information/parameters managed by the radio resource control layer processing unit 16.

The radio resource control layer processing unit 16 included in the higher layer processing unit 14 performs processing of the Radio Resource Control layer (RRC layer). The radio resource control layer processing unit 16 manages various types of configuration information/parameters of the terminal apparatus 1. The radio resource control layer processing unit 16 sets various types of configuration information/parameters based on a higher layer signaling received from the base station apparatus 3. In other words, the radio resource control layer processing unit 16 sets the various configuration information/parameters based on the information indicating the various configuration information/parameters received from the base station apparatus 3.

The radio transmission and/or reception unit 10 performs processing of the physical layer, such as modulation, demodulation, coding, and decoding. The radio transmission and/or reception unit 10 demultiplexes, demodulates, and decodes a signal received from the base station apparatus 3, and outputs the information resulting from the decoding to the higher layer processing unit 14. The radio transmission and/or reception unit 10 generates a transmit signal by modulating and coding data, and performs transmission to the base station apparatus 3. The radio transmission and/or reception unit 10 outputs, to the higher layer processing unit 14, the higher layer signaling (RRC message), DCI, and the like received from the base station apparatus 3. Additionally, the radio transmission and/or reception unit 10 generates and transmits an uplink signal, based on an indication from the higher layer processing unit 14. The radio transmission and/or reception unit 10 may function to repeatedly transmit the transport block to the base station apparatus 3, based on an indication from the higher layer processing unit 14. In a case that the repetition transmission of the transport block is configured, the radio transmission and/or reception unit 10 may repeatedly transmit the same transport block. The number of repetition transmissions may be given based on an indication from the higher layer processing unit 14. The radio transmission and/or reception unit 10 transmits the PUSCH in the aggregation transmission, based on information related to the first number of repetitions, the first number, and the second number which are indicated by the higher layer processing unit 14. The radio transmission and/or reception unit 10 may function to control the aggregation transmission, based on prescribed conditions. Specifically, the radio transmission and/or reception unit 10 may function, in a case of satisfying a first condition, to apply the same symbol allocation to each slot and repeatedly transmit the transport block N times in continuous N slots in a case that the second aggregation transmission parameter is configured and to transmit the transport block once in a case that the second aggregation transmission parameter is not configured. Here, the value of N is indicated in the second aggregation transmission parameter. Additionally, the radio transmission and/or reception unit 10 may function, in a case of satisfying a second condition, to apply the mini-slot aggregation transmission and transmit the transport block. The first condition at least includes the DCI received from the base station apparatus 3 and indicating the PUSCH mapping type as the type A. The second condition at least includes the DCI received from the base station apparatus 3 and indicating the PUSCH mapping type as the type B. The radio transmission and/or reception unit 10 may function to receive one or multiple reference signals in a certain cell. The radio transmission and/or reception unit 10 may function to receive information specifying one or multiple PRACH occasions (e.g., SSB index information and/or mask index information). The radio transmission and/or reception unit 10 may function to receive a signal including indication information indicating the initiation of the random access procedure. The radio transmission and/or reception unit 10 may function to receive information for receiving information specifying a prescribed index. The radio transmission and/or reception unit 10 may function to receive information specifying the index of the random access preamble. The radio transmission and/or reception unit 10 may function to transmit the random access preamble on the PRACH occasion determined by the higher layer processing unit 14.

The RF unit 12 converts (down converts) a signal received via the antenna unit 11 into a baseband signal by orthogonal demodulation and removes unnecessary frequency components. The RF unit 12 outputs a processed analog signal to the baseband unit.

The baseband unit 13 converts the analog signal input from the RF unit 12 into a digital signal. The baseband unit 13 removes a portion corresponding to a Cyclic Prefix (CP) from the converted digital signal, performs a Fast Fourier Transform (FFT) on the signal from which the CP has been removed, and extracts a signal in the frequency domain.

The baseband unit 13 generates an OFDM symbol by performing Inverse Fast Fourier Transform (IFFT) on the data, adds CP to the generated OFDM symbol, generates a baseband digital signal, and converts the baseband digital signal into an analog signal. The baseband unit 13 outputs the converted analog signal to the RF unit 12.

The RF unit 12 removes unnecessary frequency components from the analog signal input from the baseband unit 13 through a low-pass filter, up converts the analog signal into a signal of a carrier frequency, and transmits the up converted signal via the antenna unit 11. Also, the RF unit 12 amplifies power. Additionally, the RF unit 12 may function to determine transmit power for the uplink physical channel (PUSCH, PUCCH) and/or the sounding reference signal transmitted in the serving cell. The RF unit 12 is also referred to as a transmit power controller. The transmit power control unit may function to adjust the transmit power for the uplink signal by using the TPC command, and/or the path loss reference specified by the higher layer processing unit and/or parameters configured by higher layer signaling (subcarrier spacing configuration μ, reference power for the uplink physical channel (PUSCH, PUCCH) and/or the sounding reference signal, and the terminal apparatus-specific power for the uplink physical channel (PUSCH, PUCCH)), and/or the compensation coefficient for downlink path loss.

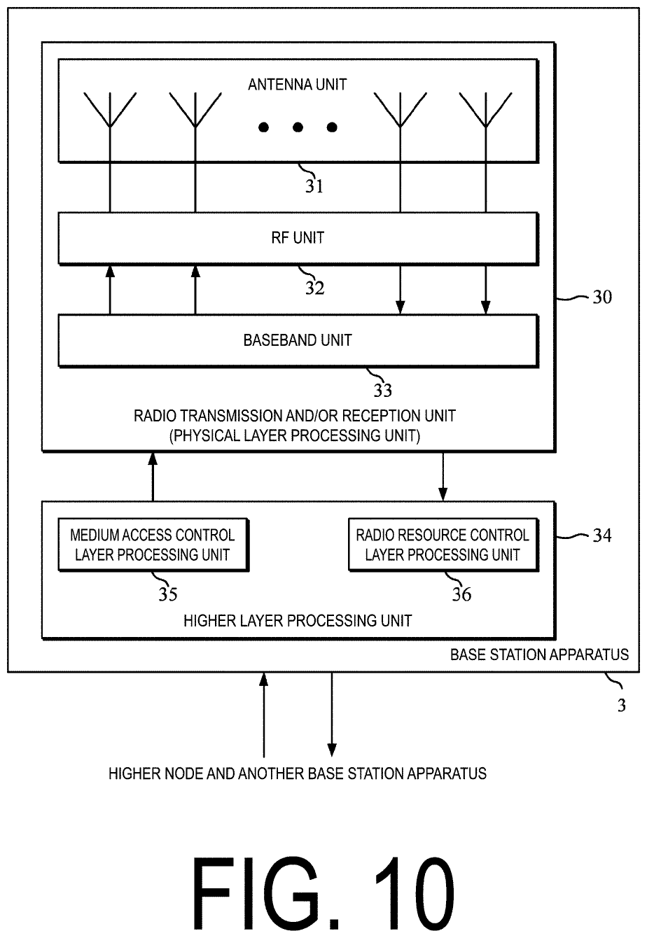

FIG. 10 is a schematic block diagram illustrating a configuration of the base station apparatus 3 according to the present embodiment. As illustrated, the base station apparatus 3 is configured to include a radio transmission and/or reception unit 30 and a higher layer processing unit 34. The radio transmission and/or reception unit 30 is configured to include an antenna unit 31, an RF unit 32, and a baseband unit 33. The higher layer processing unit 34 includes a medium access control layer processing unit 35 and a radio resource control layer processing unit 36. The radio transmission and/or reception unit 30 is also referred to as a transmitter, a receiver, a monitor unit, or a physical layer processing unit. A controller controlling operations of the units based on various conditions may be separately provided. The higher layer processing unit 34 is also referred to as a terminal control unit.

The higher layer processing unit 34 performs processing for some or all of the Medium Access Control (MAC) layer, the Packet Data Convergence Protocol (PDCP) layer, the Radio Link Control (RLC) layer, and the Radio Resource Control (RRC) layer. The higher layer processing unit 34 may function to determine whether to repeatedly transmit the transport block, based on the higher layer signaling transmitted to the terminal apparatus 1. The higher layer processing unit 34 may determine, based on the higher layer signaling transmitted to the terminal apparatus 1, whether to perform the first aggregation transmission and/or the second aggregation transmission. The higher layer processing unit 34 may function to control the symbol allocation expansion (starting symbol expansion and/or symbol number expansion), the number of dynamic repetitions, and/or the mini-slot aggregation transmission for the aggregation transmission (the second aggregation transmission), based on the higher layer signaling transmitted to the terminal apparatus 1. The higher layer processing unit 34 may determine whether to perform the frequency hopping transmission of the transport block, based on the higher layer signaling transmitted to the terminal apparatus 1. The higher layer processing unit 34 may function to control the second number, based on the higher layer signaling including the first number of repetition transmissions and/or the DCI field including the first number. The first number may be the number of repetition transmissions of the same transport block within a slot and across slots. The second number may be the number of repetition transmissions of the same transport block within a slot. The higher layer processing unit 34 may function to specify one reference signal from one or multiple reference signals, based on the random access preamble received by the radio transmission and/or reception unit 30. The higher layer processing unit 34 may specify the PRACH occasion on which the random access preamble is monitored, based on at least the SSB index information and the mask index information.

The medium access control layer processing unit 35 included in the higher layer processing unit 34 performs processing of the MAC layer. The medium access control layer processing unit 35 performs processing associated with a scheduling request, based on various types of configuration information/parameters managed by the radio resource control layer processing unit 36.

The radio resource control layer processing unit 36 included in the higher layer processing unit 34 performs processing of the RRC layer. The radio resource control layer processing unit 36 generates, or acquires from a higher node, downlink data (transport block) allocated on a physical downlink shared channel, system information, an RRC message, a MAC Control Element (CE), and the like, and outputs the generated or acquired data to the radio transmission and/or reception unit 30. Further, the radio resource control layer processing unit 36 manages various types of configuration information/parameters for each terminal apparatus 1. The radio resource control layer processing unit 36 may set various types of configuration information/parameters for each terminal apparatus 1 via higher layer signaling. In other words, the radio resource control layer processing unit 36 transmits/broadcasts information indicating various types of configuration information/parameters. The radio resource control layer processing unit 36 may transmit/report information for specifying a configuration of multiple reference signals in a certain cell.

In a case that the base station apparatus 3 transmits the RRC message, the MAC CE, and/or the PDCCH to the terminal apparatus 1, and the terminal apparatus 1 performs processing, based on the reception, the base station apparatus 3 performs processing (control of the terminal apparatus 1 and the system) assuming that the terminal apparatus is performing the above-described processing. In other words, the base station apparatus 3 sends, to the terminal apparatus 1, the RRC message, MAC CE, and/or PDCCH intended to cause the terminal apparatus to perform the processing based on the reception.

The radio transmission and/or reception unit 30 transmits higher layer signaling (RRC message), DCI, and the like to the terminal apparatus 1. The radio transmission and/or reception unit 30 receives the uplink signal transmitted from the terminal apparatus 1 based on an indication from the higher layer processing unit 34. The radio transmission and/or reception unit 30 may function to receive the repetition transmission of the transport block from the terminal apparatus 1, based on an indication from the higher layer processing unit 34. In a case that the repetition transmission of the transport block is configured, the radio transmission and/or reception unit 30 receives the repetition transmission of the same transport block. The number of repetition transmissions may be given based on an indication from the higher layer processing unit 34. The radio transmission and/or reception unit 30 receives the PUSCH in the aggregation transmission, based on the information related to the first number of repetitions, the first number, and the second number which are indicated by the higher layer processing unit 34. The radio transmission and/or reception unit 30 may function to control the aggregation transmission, based on prescribed conditions. Specifically, the radio transmission and/or reception unit 30 functions, in a case of satisfying a first condition, to apply the same symbol allocation to each slot and repeatedly receive the transport block N times in continuous N slots in a case that the second aggregation transmission parameter is configured and to receive the transport block once in a case that the second aggregation transmission parameter is not configured. Here, the value of N is indicated in the second aggregation transmission parameter. Additionally, the radio transmission and/or reception unit 30 may function, in a case of satisfying a second condition, to receive the transport block by applying the mini-slot aggregation transmission. The first condition at least includes the DCI transmitted to the terminal apparatus 1 and indicating the PUSCH mapping type as the type A. The second condition at least includes the DCI transmitted to the terminal apparatus 1 and indicating the PUSCH mapping type as the type B. The radio transmission and/or reception unit 30 functions to transmit one or multiple reference signals. The radio transmission and/or reception unit 30 may function to receive a signal including a beam failure recovery request transmitted from the terminal apparatus 1. The radio transmission and/or reception unit 30 may function to transmit information specifying one or multiple PRACH occasions (e.g., SSB index information and/or mask index information) to the terminal apparatus 1. The radio transmission and/or reception unit 30 may have a function to transmit information specifying a prescribed index. The radio transmission and/or reception unit 30 may function to transmit information specifying the index of the random access preamble. The radio transmission and/or reception unit 30 may have a function of monitoring the random access preamble in the PRACH occasion specified by the higher layer processing unit 34. In addition, some of the functions of the radio transmission and/or reception unit 30 are similar to the corresponding functions of the radio transmission and/or reception unit 10, and thus description of these functions is omitted. Note that in a case that the base station apparatus 3 is connected to one or multiple transmission reception points 4, some or all of the functions of the radio transmission and/or reception unit 30 may be included in each of the transmission reception points 4.

Further, the higher layer processing unit 34 transmits (transfers) or receives control messages or user data between the base station apparatuses 3 or between a higher network apparatus (MME, S-GW (Serving-GW)) and the base station apparatus 3. Although, in FIG. 10, other constituent elements of the base station apparatus 3, a transmission path of data (control information) between the constituent elements, and the like are omitted, it is apparent that the base station apparatus 3 is provided with multiple blocks, as constituent elements, including other functions necessary to operate as the base station apparatus 3. For example, a Radio Resource Management layer processing unit or an application layer processing unit reside in the higher layer processing unit 34. The higher layer processing unit 34 may also function to configure multiple scheduling request resources corresponding to respective multiple reference signals transmitted from the radio transmission and/or reception unit 30.

Note that “units” in the drawing refer to constituent elements to realize the functions and the procedures of the terminal apparatus 1 and the base station apparatus 3, which are also represented by the terms such as a section, a circuit, a constituting apparatus, a device, a unit, and the like.

Each of the units having the reference signs 10 to 16 included in the terminal apparatus 1 may be implemented as a circuit. Each of the units having the reference signs 30 to 36 included in the base station apparatus 3 may be implemented as a circuit.

(1) More specifically, a communication method for a terminal apparatus according to a first aspect of the present invention includes receiving a higher layer configuration including an aggregation transmission parameter and parameters to be applied to transmit power control, and in a case that the aggregation transmission parameter is configured, repeatedly transmitting a transport block N times in N slots, wherein a value for the number N is included in the aggregation transmission parameter, one or multiple path loss reference reference signal parameters are included in the parameters to be applied to the transmit power control, a downlink path loss estimation for nth PUSCH transmission being calculated by using a path loss reference reference signal identified by the one or multiple path loss reference reference signal parameters, to perform power control.

(2) In a communication method according to a second aspect of the present invention, in addition to the communication method of the first aspect, the parameter for the path loss reference reference signal is a parameter for a reference signal defined as a remainder obatined by dividing n by a total number of reference signals included in a set of reference signals to be used for PUSCH path loss estimation.

(3) In a communication method according to a third aspect of the present invention, in addition to the communication method of the first aspect, the parameter for the path loss reference reference signal is a parameter for a path loss reference reference signal corresponding to spatial relation information identified as a remainder obtained by dividing, by a total number of pieces of spatial relation information associated with one or multiple PUCCH resources, a sum of n and a piece of the spatial relation information associated with a PUCCH resource with a minimum ID among the one or multiple PUCCH resources.

(4) A communication method for a base station apparatus according to a fourth aspect of the present invention includes transmitting, to a terminal apparatus, a higher layer configuration including an aggregation transmission parameter and parameters to be applied to transmit power control, and in a case that the aggregation transmission parameter is configured, repeatedly receiving a transport block N times in N slots, wherein a value for the N is included in the aggregation transmission parameter, one or multiple path loss reference reference signal parameters are included in the parameters to be applied to the transmit power control, a signal is received, the signal being a signal for which a downlink path loss estimation for nth PUSCH transmission is calculated by using a path loss reference reference signal identified by the one or multiple path loss reference reference signal parameters and for which power control is performed.

(5) A terminal apparatus according to a fifth aspect of the present invention includes a receiver configured to receive a higher layer configuration including an aggregation transmission parameter and parameters to be applied to transmit power control, and a transmitter configured to repeatedly transmit, in a case that the aggregation transmission parameter is configured, a transport block N times in N slots, wherein a value for the number N is included in the aggregation transmission parameter, one or multiple path loss reference reference signal parameters are included in the parameters to be applied to the transmit power control, the transmitter calculates a downlink path loss estimation for nth PUSCH transmission by using a path loss reference reference signal identified by the one or multiple path loss reference reference signal parameters and performs power control.

(6) A base station apparatus according to a sixth aspect of the present invention includes a transmitter configured to transmit, to a terminal apparatus, a higher layer configuration including an aggregation transmission parameter and parameters to be applied to transmit power control, and a receiver configured to repeatedly receive, in a case that the aggregation transmission parameter is configured, a transport block N times in N slots, wherein a value for the number N is included in the aggregation transmission parameter, one or multiple path loss reference reference signal parameters are included in the parameters to be applied to the transmit power control, the receiver receives a signal for which a downlink path loss estimation for nth PUSCH transmission is calculated by using a path loss reference reference signal identified by the one or multiple path loss reference reference signal parameters and for which power control is performed.

(7) An integrated circuit according to a seventh aspect of the present invention is an integrated circuit mounted in a terminal apparatus, the integrated circuit including a receiver configured to receive a higher layer configuration including an aggregation transmission parameter and parameters to be applied to transmit power control, and a transmitter configured to repeatedly transmit, in a case that the aggregation transmission parameter is configured, a transport block N times in N slots, wherein a value for the number N is included in the aggregation transmission parameter, one or multiple path loss reference reference signal parameters are included in the parameters to be applied to the transmit power control, the transmitter calculates a downlink path loss estimation for nth PUSCH transmission by using a path loss reference reference signal identified by the one or multiple path loss reference reference signal parameters and performs power control.

(8) An integrated circuit according to an eighth aspect of the present invention is an integrated circuit mounted in a base station apparatus, the integrated circuit including a transmitter configured to transmit, to a terminal apparatus, a higher layer configuration including an aggregation transmission parameter and parameters to be applied to transmit power control, and a receiver configured to repeatedly receive, in a case that the aggregation transmission parameter is configured, a transport block N times in N slots, wherein a value for the number N is included in the aggregation transmission parameter, one or multiple path loss reference reference signal parameters are included in the parameters to be applied to the transmit power control, the receiver receives a signal for which a downlink path loss estimation for nth PUSCH transmission is calculated by using a path loss reference reference signal identified by the one or multiple path loss reference reference signal parameters and for which power control is performed.

A program running on an apparatus according to the present invention may serve as a program that controls a Central Processing Unit (CPU) and the like to cause a computer to operate in such a manner as to realize the functions of the above-described embodiment according to the present invention. Programs or the information handled by the programs are temporarily stored in a volatile memory such as a Random Access Memory (RAM), a non-volatile memory such as a flash memory, a Hard Disk Drive (HDD), or any other storage device system.

Note that a program for realizing the functions of the embodiments according to the present invention may be recorded in a computer-readable recording medium. It may be implemented by causing a computer system to read and execute the program recorded on this recording medium. It is assumed that the “computer system” refers to a computer system built into the apparatuses, and the computer system includes an operating system and hardware components such as a peripheral device. Furthermore, the “computer-readable recording medium” may be any of a semiconductor recording medium, an optical recording medium, a magnetic recording medium, a medium dynamically retaining the program for a short time, or any other computer readable recording medium.

Furthermore, each functional block or various characteristics of the apparatuses used in the above-described embodiment may be implemented or performed on an electric circuit, for example, an integrated circuit or multiple integrated circuits. An electric circuit designed to perform the functions described in the present specification may include a general purpose processor, a digital signal processor (DSP), an application specific integrated circuit (ASIC), a field programmable gate array (FPGA), or other programmable logic devices, discrete gates or transistor logic, discrete hardware components, or a combination thereof. The general purpose processor may be a microprocessor or may be a processor, a controller, a micro-controller, or a state machine of known type, instead. The above-mentioned electric circuit may include a digital circuit, or may include an analog circuit. Furthermore, in a case that with advances in semiconductor technology, a circuit integration technology appears that replaces the present integrated circuits, it is also possible to use a new integrated circuit based on the technology according to one or more aspects of the present invention.

Note that, in the embodiments according to the present invention, an example has been described in which the present invention is applied to a communication system including a base station apparatus and a terminal apparatus, but the present invention can also be applied in a system in which terminals communicate as in the case of Device to Device (D2D).

Note that the invention of the present application is not limited to the above-described embodiments. Although apparatuses have been described as an example in the embodiment, the invention of the present application is not limited to these apparatuses, and is applicable to a stationary type or a non-movable type electronic apparatus installed indoors or outdoors such as a terminal apparatus or a communication apparatus, for example, an AV device, a kitchen device, a cleaning or washing machine, an air-conditioning device, office equipment, a vending machine, and other household appliances.

Although, the embodiments of the present invention have been described in detail above referring to the drawings, the specific configuration is not limited to the embodiments and includes, for example, design changes within the scope not depart from the gist of the present invention. Furthermore, in the present invention, various modifications are possible within the scope of claims, and embodiments that are made by suitably combining technical means disclosed according to the different embodiments are also included in the technical scope of the present invention. Furthermore, a configuration in which elements described in the respective embodiments and having mutually the same effects, are substituted for one another is also included.

1. A communication method for a terminal apparatus, the communication method comprising:
receiving a higher layer configuration including an aggregation transmission parameter and parameters to be applied to transmit power control; and
in a case that the aggregation transmission parameter is configured, repeatedly transmitting a transport block N times in N slots, wherein
a value for the number N is included in the aggregation transmission parameter,
one or multiple path loss reference reference signal parameters are included in the parameters to be applied to the transmit power control, and
a downlink path loss estimation corresponding to nth transmission of the N repeated transmissions is calculated by using a path loss reference reference signal identified by the one or multiple path loss reference reference signal parameters, to perform transmit power control for the nth transmission.

2. The communication method according to claim 1, wherein
the one or multiple path loss reference reference signal parameters are parameters for identifying the path loss reference reference signal defined as a remainder obtained by dividing the value of the n by a total number of reference signals included in a set of reference signals to be used for PUSCH path loss estimation.

3. The communication method according to claim 1, wherein
the one or multiple path loss reference reference signal parameters are parameters for identifying, as the path loss reference reference signal, a reference signal corresponding to spatial relation information identified as a remainder obtained by dividing, by a total number of one or multiple pieces of spatial relation information each associated with a PUCCH resource, a sum of the value of the n and a value of an index of spatial relation information associated with a PUCCH resource with a minimum index value among the one or multiple pieces of spatial relation information.

4. A communication method for a base station apparatus, the communication method comprising:
transmitting, to a terminal apparatus, a higher layer configuration including an aggregation transmission parameter and parameters to be applied to transmit power control; and
in a case that the aggregation transmission parameter is configured, repeatedly receiving a transport block N times in N slots, wherein
a value for the number N is included in the aggregation transmission parameter,
one or multiple path loss reference reference signal parameters are included in the parameters to be applied to the transmit power control, and
a signal received in nth reception of the N repeated receptions is a signal for which the terminal apparatus calculates a corresponding downlink path loss estimation by using a path loss reference reference signal identified by the one or multiple path loss reference reference signal parameters and performs transmit power control.

5. A terminal apparatus comprising:
a receiver configured to receive a higher layer configuration including an aggregation transmission parameter and parameters to be applied to transmit power control; and
a transmitter configured to repeatedly transmit, in a case that the aggregation transmission parameter is configured, a transport block N times in N slots, wherein
a value for the number N is included in the aggregation transmission parameter,
one or multiple path loss reference reference signal parameters are included in the parameters to be applied to the transmit power control, and
a downlink path loss estimation corresponding to nth transmission of the N repeated transmissions is calculated by using a path loss reference reference signal identified by the one or multiple path loss reference reference signal parameters, to perform transmit power control for the nth transmission.

6. A base station apparatus comprising:
a transmitter configured to transmit, to a terminal apparatus, a higher layer configuration including an aggregation transmission parameter and parameters to be applied to transmit power control; and
a receiver configured to repeatedly receive, in a case that the aggregation transmission parameter is configured, a transport block N times in N slots, wherein
a value for the number N is included in the aggregation transmission parameter,
one or multiple path loss reference reference signal parameters are included in the parameters to be applied to the transmit power control, and
a signal received in nth reception of the N repeated receptions is a signal for which the terminal apparatus calculates a corresponding downlink path loss estimation by using a path loss reference reference signal identified by the one or multiple path loss reference reference signal parameters and performs transmit power control.

7. An integrated circuit mounted in a terminal apparatus, the integrated circuit comprising:
a receiving unit configured to receive a higher layer configuration including an aggregation transmission parameter and parameters to be applied to transmit power control; and
a transmitting unit configured to repeatedly transmit, in a case that the aggregation transmission parameter is configured, a transport block N times in N slots, wherein
a value for the number N is included in the aggregation transmission parameter,
one or multiple path loss reference reference signal parameters are included in the parameters to be applied to the transmit power control, and
a downlink path loss estimation corresponding to nth transmission of the N repeated transmissions is calculated by using a path loss reference reference signal identified by the one or multiple path loss reference reference signal parameters, to perform transmit power control for the nth transmission.

8. An integrated circuit mounted in a base station apparatus, the integrated circuit comprising:
a transmitting unit configured to transmit, to a terminal apparatus, a higher layer configuration including an aggregation transmission parameter and parameters to be applied to transmit power control; and
a receiving unit configured to repeatedly receive, in a case that the aggregation transmission parameter is configured, a transport block N times in N slots, wherein
a value for the number N is included in the aggregation transmission parameter,
one or multiple path loss reference reference signal parameters are included in the parameters to be applied to the transmit power control, and
a signal received in nth reception of the N repeated receptions is a signal for which the terminal apparatus calculates a corresponding downlink path loss estimation by using a path loss reference reference signal identified by the one or multiple path loss reference reference signal parameters and performs transmit power control.
